(19) United States
(12) Patent Application Publication
(10) Pub. No.: US 2025/0322266 A1
(43) Pub. Date: Oct. 16, 2025

(54) AUTONOMOUS AND SEMANTICALLY CONSISTENT MESSAGE AUGMENTATION PIPELINES

(71) Applicant: Optum, Inc., Minnetonka, MN (US)

(72) Inventors: Steven L. OLSON, Maple Grove, MN (US); Carlos W. MORATO, Sammamish, WA (US); Zahra RAJABI, Vienna, VA (US); Jennifer A. WHITLEY, Berkeley, CA (US)

(21) Appl. No.: 18/943,236

(22) Filed: Nov. 11, 2024

Related U.S. Application Data
(60) Provisional application No. 63/634,530, filed on Apr. 16, 2024.

(51) Int. Cl. G06N 5/022

(52) U.S. Cl. CPC G06N 5/022

(57) ABSTRACT

Various embodiments of the present disclosure provide automated message processing techniques that improve traditional communication systems, such as those that interface between a user and a plurality of requesting entities. The techniques include identifying a message that (i) is directed to a user inbox, (ii) is associated with an automated task category of a plurality of different automated task categories, and (iii) comprises message text data reflective of the automated task category. The techniques include generating a coded model output (i) based on the message text data and a domain knowledge index and (ii) that comprises a semantic intent classification and a shared embedding code and identifying the automated task category based on the semantic intent classification and the shared embedding code. The techniques include generating, using the domain knowledge index, a predicted response for the message based on the automated task category and modifying message with the predicted response.

### CROSS-REFERENCE TO RELATED APPLICATIONS

This application claims the benefit of U.S. Provisional Application No. 63/634,530, entitled “AUTOMATED INBOX MANAGEMENT SOLUTION,” and filed Apr. 16, 2024, the entire contents of which are herein incorporated by reference.

### BACKGROUND

Various embodiments of the present disclosure address technical challenges related to computer interpretation techniques, such as those used in message handling communication systems associated with disparate terminologies. Traditionally, computer interpretation of natural language text leverages language models to transform natural language text into concepts that are interpretable to a computer. Generally, the accuracy of language models is tied to the data used to train the model, which prevents numerous technical challenges including model drift as the data used to train the model is less relevant to real world data. Moreover, language models are traditionally integrated with domain-level terminologies that encompass terminologies that are used by all entities within a domain. For example, a language model may be integrated with a common dictionary that is used by several enterprises operating within the domain. This allows language models to make domain-specific predictions but prevents the same models from making enterprise-specific prediction. These deficiencies lead to several gaps in understanding text that fail to tailor the understanding of text to the specific context in which it is delivered.

Various embodiments of the present disclosure make important contributions to traditional computer interpretation techniques by addressing these technical challenges, among others.

### BRIEF SUMMARY

Various embodiments of the present disclosure provide improved computer interpretation techniques that may be applied in a communication system to improve message handling. Using the improved computer interpretation techniques, some embodiments of the present disclosure may implement a machine learning semantic search framework that is integrated with a domain knowledge index to align data from existing and new protocols to user friendly terminology that may be used in messages between users of a communication system. To do so, the present disclosure describes a new data structure, the domain knowledge index, that ties the semantic understanding of a message to each component of a multi-stage automated process performed by the machine learning semantic search framework. This enables the consistent use and transitioning between enterprise, domain-level, and user-level terminologies within a prediction domain and removes information loss across various stages of the multi-stage process.

In some embodiments, a computer-implemented method includes identifying, by one or more processors, a message that (i) is directed to a user inbox, (ii) is associated with an automated task category of a plurality of different automated task categories, and (iii) comprises message text data reflective of the automated task category; generating, by the one or more processors and using a machine learning semantic search framework, a coded model output (i) based on the message text data and a domain knowledge index and (ii) that comprises a semantic intent classification and a shared embedding code; identifying, by the one or more processors, the automated task category based on the semantic intent classification and the shared embedding code; generating, by the one or more processors and using the domain knowledge index, a predicted response for the message based on the automated task category; and modifying, by the one or more processors, the message with the predicted response.

In some embodiments, a system includes memory and one or more processors communicatively coupled to the memory, the one or more processors are configured to identify a message that (i) is directed to a user inbox, (ii) is associated with an automated task category of a plurality of different automated task categories, and (iii) comprises message text data reflective of the automated task category; generate, using a machine learning semantic search framework, a coded model output (i) based on the message text data and a domain knowledge index and (ii) that comprises a semantic intent classification and a shared embedding code; identify the automated task category based on the semantic intent classification and the shared embedding code; generate, using the domain knowledge index, a predicted response for the message based on the automated task category; and modify the message with the predicted response.

In some embodiments, one or more non-transitory computer-readable storage media includes instructions that, when executed by one or more processors, cause the one or more processors to identify a message that (i) is directed to a user inbox, (ii) is associated with an automated task category of a plurality of different automated task categories, and (iii) comprises message text data reflective of the automated task category; generate, using a machine learning semantic search framework, a coded model output (i) based on the message text data and a domain knowledge index and (ii) that comprises a semantic intent classification and a shared embedding code; identify the automated task category based on the semantic intent classification and the shared embedding code; generate, using the domain knowledge index, a predicted response for the message based on the automated task category; and modify the message with the predicted response.

### BRIEF DESCRIPTION OF THE DRAWINGS

FIG. 1 provides an example overview of an architecture in accordance with some embodiments of the present disclosure.

FIG. 2 provides an example predictive data analysis computing entity in accordance with some embodiments of the present disclosure.

FIG. 3 provides an example client computing entity in accordance with some embodiments of the present disclosure.

FIG. 4 is a dataflow diagram showing example data structures and modules for handling a message in accordance with some embodiments discussed herein.

FIG. 5 is an operational example of a message augmentation pipeline for augmenting a message in accordance with some embodiments discussed herein.

FIG. 6 is an operational example of an automated task category in accordance with some embodiments discussed herein.

FIG. 7 is a flowchart diagram of an example process for augmenting a message in accordance with some embodiments discussed herein.

### DETAILED DESCRIPTION

Various embodiments of the present disclosure are described more fully hereinafter with reference to the accompanying drawings, in which some, but not all embodiments of the present disclosure are shown. Indeed, the present disclosure may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “example” are used to be examples with no indication of quality level. Terms such as “computing,” “determining,” “generating,” and/or similar words are used herein interchangeably to refer to the creation, modification, or identification of data. Further, “based on,” “based at least in part on,” “based at least on,” “based upon,” and/or similar words are used herein interchangeably in an open-ended manner such that they do not necessarily indicate being based only on or based solely on the referenced element or elements unless so indicated. Like numbers refer to like elements throughout.

### I. COMPUTER PROGRAM PRODUCTS, METHODS, AND COMPUTING ENTITIES

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

A non-volatile computer-readable storage medium may include a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), crasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

A volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### II. EXAMPLE FRAMEWORK

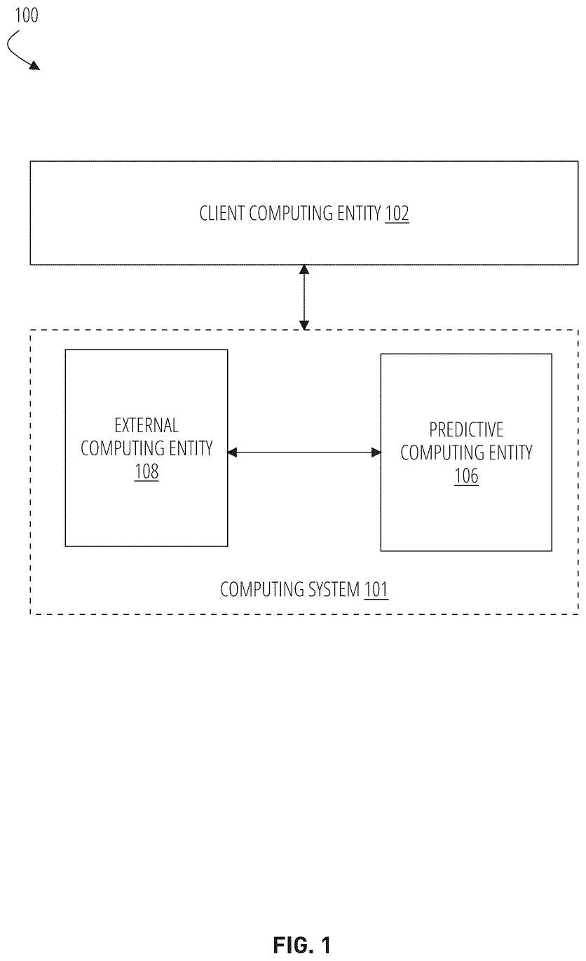

FIG. 1 provides an example overview of an architecture 100 in accordance with some embodiments of the present disclosure. The architecture 100 includes a computing system 101 configured to facilitate communication between client computing entities 102, process the messages to generate predicted responses, and provide the messages and/or predicted responses to the client computing entities 102. The example architecture 100 may be used in a plurality of domains and not limited to any specific application as disclosed herewith. The plurality of domains may include communication, banking, healthcare, industrial, manufacturing, education, retail, to name a few.

In accordance with various embodiments of the present disclosure, one or more machine learning models may be trained to generate predicted responses in various forms, including augmented messages, automated responses, and/or the like. The models may form a machine learning semantic search framework that may be configured to automatically process and augment a message between two entities. This technique will lead to more computer interpretation of messages and, ultimately, reduce memory and processing resources traditionally required for the storage and manual handling of messages.

In some embodiments, the computing system 101 may communicate with at least one of the client computing entities 102 using one or more communication networks. Examples of communication networks include any wired or wireless communication network including, for example, a wired or wireless local area network (LAN), personal area network (PAN), metropolitan area network (MAN), wide area network (WAN), or the like, as well as any hardware, software, and/or firmware required to implement it (such as, e.g., network routers, and/or the like).

The computing system 101 may include a predictive computing entity 106 and one or more external computing entities 108. The predictive computing entity 106 and/or one or more external computing entities 108 may be individually and/or collectively configured to receive messages from client computing entities 102, process the messages to generate outputs, such as predicted responses, and/or the like, and provide the generated outputs to the client computing entities 102.

For example, as discussed in further detail herein, the predictive computing entity 106 and/or one or more external computing entities 108 comprise storage subsystems that may be configured to store input data, training data, and/or the like that may be used by the respective computing entities to perform predictive data analysis and/or training operations of the present disclosure. In addition, the storage subsystems may be configured to store model definition data used by the respective computing entities to perform various predictive data analysis and/or training tasks. The storage subsystem may include one or more storage units, such as multiple distributed storage units that are connected through a computer network. Each storage unit in the respective computing entities may store at least one of one or more data assets and/or one or more data about the computed properties of one or more data assets. Moreover, each storage unit in the storage systems may include one or more non-volatile storage or memory media including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

In some embodiments, the predictive computing entity 106 and/or one or more external computing entities 108 are communicatively coupled using one or more wired and/or wireless communication techniques. The respective computing entities may be specially configured to perform one or more steps/operations of one or more techniques described herein. By way of example, the predictive computing entity 106 may be configured to train, implement, use, update, and evaluate machine learning models in accordance with one or more training and/or inference operations of the present disclosure. In some examples, the external computing entities 108 may be configured to train, implement, use, update, and evaluate machine learning models in accordance with one or more training and/or inference operations of the present disclosure.

In some example embodiments, the predictive computing entity 106 may be configured to receive and/or transmit one or more datasets, objects, and/or the like from and/or to the external computing entities 108 to perform one or more steps/operations of one or more techniques (e.g., computer interpretation techniques, message handling techniques, and/or the like) described herein. The external computing entities 108, for example, may include and/or be associated with one or more entities that may be configured to receive, transmit, store, manage, and/or facilitate datasets, such as the historical data index, domain data index, domain knowledge index, and/or the like. The external computing entities 108, for example, may include data sources that may provide such datasets, and/or the like to the predictive computing entity 106 which may leverage the datasets to perform one or more steps/operations of the present disclosure, as described herein. In some examples, the datasets may include an aggregation of data from across a plurality of external computing entities 108 into one or more aggregated datasets. The external computing entities 108, for example, may be associated with one or more data repositories, cloud platforms, compute nodes, organizations, and/or the like, which may be individually and/or collectively leveraged by the predictive computing entity 106 to obtain and aggregate data for a prediction domain.

In some example embodiments, the predictive computing entity 106 may be configured to receive a trained machine learning model trained and subsequently provided by the one or more external computing entities 108. For example, the one or more external computing entities 108 may be configured to perform one or more training steps/operations of the present disclosure to train a machine learning model, as described herein. In such a case, the trained machine learning model may be provided to the predictive computing entity 106, which may leverage the trained machine learning model to perform one or more inference steps/operations of the present disclosure. In some examples, feedback (e.g., evaluation data, ground truth data, etc.) from the use of the machine learning model may be recorded by the predictive computing entity 106. In some examples, the feedback may be provided to the one or more external computing entities 108 to continuously train the machine learning model over time. In some examples, the feedback may be leveraged by the predictive computing entity 106 to continuously train the machine learning model over time. In this manner, the computing system 101 may perform, via one or more combinations of computing entities, one or more prediction, training, and/or any other machine learning-based techniques of the present disclosure.

### A. Example Predictive Computing Entity

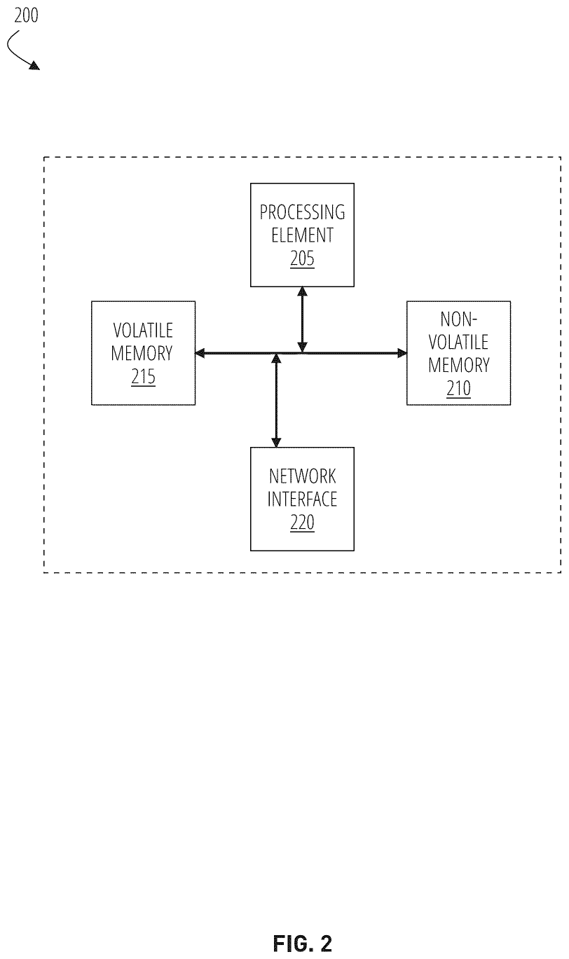

FIG. 2 provides an example computing entity 200 in accordance with some embodiments of the present disclosure. The computing entity 200 is an example of the predictive computing entity 106 and/or external computing entities 108 of FIG. 1. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, training one or more machine learning models, monitoring, evaluating, comparing, and/or similar terms used herein interchangeably. In some embodiments, these functions, operations, and/or processes may be performed on data, content, information, and/or similar terms used herein interchangeably. In some embodiments, the one computing entity (e.g., predictive computing entity 106, etc.) may train and use one or more machine learning models described herein. In other embodiments, a first computing entity (e.g., predictive computing entity 106, etc.) may use one or more machine learning models that may be trained by a second computing entity (e.g., external computing entity 108) communicatively coupled to the first computing entity. The second computing entity, for example, may train one or more of the machine learning models described herein, and subsequently provide the trained machine learning model(s) (e.g., optimized weights, code sets, etc.) to the first computing entity over a network.

As shown in FIG. 2, in some embodiments, the computing entity 200 may include, or be in communication with, one or more processing elements 205 (also referred to as processors, processing circuitry, and/or similar terms used herein interchangeably) that communicate with other elements within the computing entity 200 via a bus, for example. As will be understood, the processing element 205 may be embodied in a number of different ways.

For example, the processing element 205 may be embodied as one or more complex programmable logic devices (CPLDs), microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

In some embodiments, the computing entity 200 may further include, or be in communication with, non-volatile media (also referred to as non-volatile storage, memory, memory storage, memory circuitry, and/or similar terms used herein interchangeably). In some embodiments, the non-volatile media may include one or more non-volatile memory 210, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

As will be recognized, the non-volatile media may store databases, database instances, database management systems, data, applications, programs, program modules, scripts, code (e.g., source code, object code, byte code, compiled code, interpreted code, machine code, etc.) that embodies one or more machine learning models or other computer functions described herein, executable instructions, and/or the like. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

In some embodiments, the computing entity 200 may further include, or be in communication with, volatile media (also referred to as volatile storage, memory, memory storage, memory circuitry, and/or similar terms used herein interchangeably). In some embodiments, the volatile media may also include one or more volatile memory 215, including, but not limited to, RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile storage or memory media may be used to store at least portions of the databases, database instances, database management systems, data, applications, programs, program modules, code (source code, object code, byte code, compiled code, interpreted code, machine code) that embodies one or more machine learning models or other computer functions described herein, executable instructions, and/or the like being executed by, for example, the processing element 205. Thus, the databases, database instances, database management systems, data, applications, programs, program modules, code (source code, object code, byte code, compiled code, interpreted code, machine code) that embodies one or more machine learning models or other computer functions described herein, executable instructions, and/or the like may be used to control certain aspects of the operation of the computing entity 200 with the assistance of the processing element 205 and operating system.

As indicated, in some embodiments, the computing entity 200 may also include one or more network interfaces 220 for communicating with various computing entities (e.g., the client computing entity 102, external computing entities, etc.), such as by communicating data, code, content, information, and/or similar terms used herein interchangeably that may be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In some embodiments, the computing entity 200 communicates with another computing entity for uploading or downloading data or code (e.g., data or code that embodies or is otherwise associated with one or more machine learning models). Similarly, the computing entity 200 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the computing entity 200 may include, or be in communication with, one or more input elements, such as a keyboard input, a mouse input, a touch screen/display input, motion input, movement input, audio input, pointing device input, joystick input, keypad input, and/or the like. The computing entity 200 may also include, or be in communication with, one or more output elements (not shown), such as audio output, video output, screen/display output, motion output, movement output, and/or the like.

### B. Example Client Computing Entity

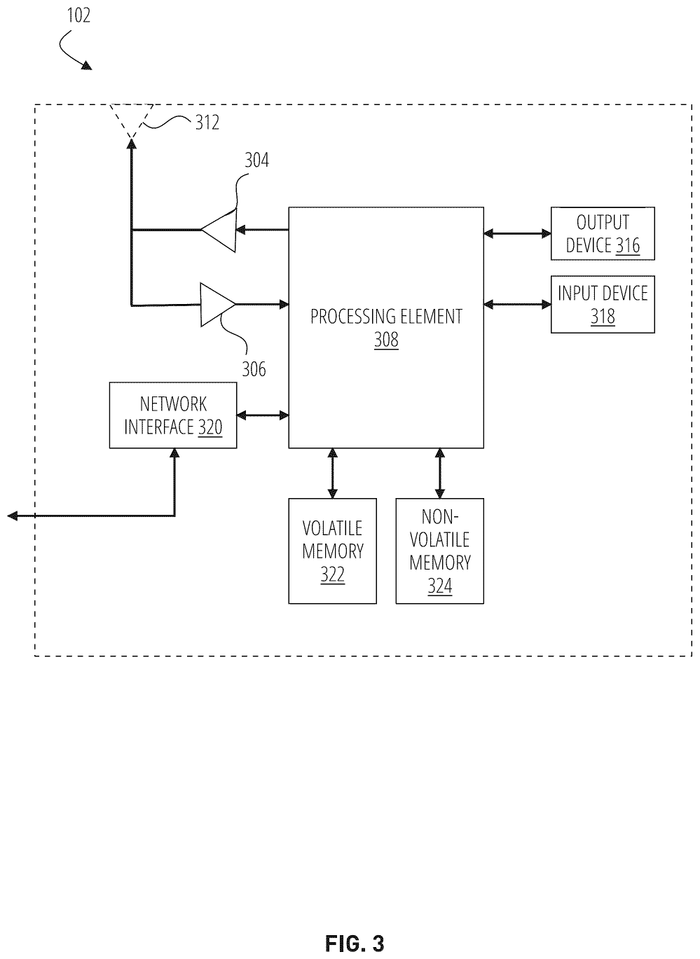

FIG. 3 provides an example client computing entity in accordance with some embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 may be operated by various parties. As shown in FIG. 3, the client computing entity 102 may include an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may include signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with any of a number of wireless communication standards and protocols, such as those described above with regard to the computing entity 200. In some embodiments, the client computing entity 102 may operate in accordance with multiple wireless communication standards and protocols, such as UMTS, CDMA2000, 1×RTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the client computing entity 102 may operate in accordance with multiple wired communication standards and protocols, such as those described above with regard to the computing entity 200 via a network interface 320.

Via these communication standards and protocols, the client computing entity 102 may communicate with various other entities using mechanisms such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The client computing entity 102 may also download code, changes, add-ons, and updates, for instance, to its firmware, software (e.g., including executable instructions, applications, program modules), and operating system.

According to some embodiments, the client computing entity 102 may include location determining aspects, devices, modules, functionalities, and/or similar words used herein interchangeably. For example, the client computing entity 102 may include outdoor positioning aspects, such as a location module adapted to acquire, for example, latitude, longitude, altitude, geocode, course, direction, heading, speed, universal time (UTC), date, and/or various other information/data. In some embodiments, the location module may acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the DecimalDegrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating the position of the client computing entity 102 in connection with a variety of other systems, including cellular towers, Wi-Fi access points, and/or the like. Similarly, the client computing entity 102 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops), and/or the like. For instance, such technologies may include the iBeacons, Gimbal proximity beacons, Bluetooth Low Energy (BLE) transmitters, NFC transmitters, and/or the like. These indoor positioning aspects may be used in a variety of settings to determine the location of someone or something to within inches or centimeters.

The client computing entity 102 may also comprise a user interface (that may include an output device 316 (e.g., display, speaker, tactile instrument, etc.) coupled to a processing element 308) and/or a user input interface (coupled to a processing element 308). For example, the user interface may be a user application, browser, user interface, and/or similar words used herein interchangeably executing on and/or accessible via the client computing entity 102 to interact with and/or cause display of information/data from the computing entity 200, as described herein. The user input interface may comprise any of a plurality of input devices 318 (or interfaces) allowing the client computing entity 102 to receive code and/or data, such as a keypad (hard or soft), a touch display, voice/speech or motion interfaces, or other input device. In some embodiments including a keypad, the keypad may include (or cause display of) the conventional numeric (0-9) and related keys (#, *), and other keys used for operating the client computing entity 102 and may include a full set of alphabetic keys or set of keys that may be activated to provide a full set of alphanumeric keys. In addition to providing input, the user input interface may be used, for example, to activate or deactivate certain functions, such as screen savers and/or sleep modes.

The client computing entity 102 may also include volatile memory 322 and/or non-volatile memory 324, which may be embedded and/or may be removable. For example, the non-volatile memory 324 may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory 322 may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile memory may store databases, database instances, database management systems, data, applications, programs, program modules, scripts, code (source code, object code, byte code, compiled code, interpreted code, machine code, etc.) that embodies one or more machine learning models or other computer functions described herein, executable instructions, and/or the like to implement the functions of the client computing entity 102. As indicated, this may include a user application that is resident on the client computing entity 102 or accessible through a browser or other user interface for communicating with the computing entity 200 and/or various other computing entities.

In another embodiment, the client computing entity 102 may include one or more components or functionalities that are the same or similar to those of the computing entity 200, as described in greater detail above. In one such embodiment, the client computing entity 102 downloads, e.g., via network interface 320, code embodying machine learning model(s) from the computing entity 200 so that the client computing entity 102 may run a local instance of the machine learning model(s). As will be recognized, these architectures and descriptions are provided for example purposes only and are not limited to the various embodiments.

In various embodiments, the client computing entity 102 may be embodied as an artificial intelligence (AI) computing entity, such as an Amazon Echo, Amazon Echo Dot, Amazon Show, Google Home, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage module, and/or accessible over a network. In various embodiments, the AI computing entity may be configured to retrieve and/or execute one or more of the predefined program algorithms upon the occurrence of a predefined trigger event.

### III. EXAMPLES OF CERTAIN TERMS

In some embodiments, the term “message” refers to a data entity that describes a communication between two computing devices. A message, for example, may include a textual communication that is provided to a user from a sender. By way of example, a message may include electronic mail (email), short message service text, a call transcript, and/or another form of communication between a sender and a user. A message may include message text data and/or contextual data associated with the sender of the message. The message text data, for example, may be reflective of information, a request, and/or the like that is provided by the sender to the user via the message. As an example, with reference to a clinical domain, a sender may include a patient and a message may state “Hello doctor, I'm almost out of my Ozempic medication, may you please send a refill to my pharmacy, but please make it for only one month as I cannot afford a 90 refill.”

In some embodiments, a message is routed, via one or more application programming interfaces (API), from a sender to a user inbox to deliver a communication to the user. In some examples, a custom API is used to extract the message before it is reviewed by a user. The message may be extracted to perform one or more message augmentation techniques of the present disclosure. The message augmentation techniques, for example, may include identifying information, such as the message text data, and/or the like, that is associated with the message, receiving additional information based on the message text data, and applying a set of query assertions to the message to receive a predicted response.

In some embodiments, the term “message text data” refers to a textual segment of a message. The message text data may include a textual representation of information provided by a message. For instance, message text data may be reflective of a sender's intent, query, notification, and/or the like. In some examples, message text data may describe a request for the performance of an action by the user. By way of example, message text data may be reflective of an automated task category.

In some embodiments, the term “sender” refers to an entity that provides a message to a user. A sender may be any automated, synthetic, or real entity that requests a service in a prediction domain. For instance, a sender may be an automated agent that is triggered to provide a message based on one or more triggering criteria (e.g., an event-based alert, a time-based alert, etc.). In addition, or alternatively, a sender may include a human actor that provides a natural language message to a user. By way of example, in a clinical prediction domain, a sender may be a patient that provides a message to a healthcare provider to request a clinical action on the patient's behalf. In some examples, the sender may be an automated agent that provides a message to initiate the clinical action on the patient's behalf.

In some embodiments, the term “sender identifier” refers to a data entity that identifies a sender. A sender identifier, for example, may include a numeric, alpha-numeric, and/or any other value that identifies a particular entity within a prediction domain. By way of example, a sender identifier may include an assigned code, a name, a username, an email address, a phone number, and/or the like. In some examples, a sender identifier may include an encoded representation (e.g., hash, etc.) of identifiable information for a sender.

In some embodiments, the term “sender inbox” refers to a portion of memory that receives and stores a plurality of messages for a sender. A sender inbox, for example, may include a portion of a digital communication application (e.g., an information manager software system, etc.) that stores messages received by a sender, facilitates the composition of new messages from the sender, and/or provides messages from the sender to one or more recipients, such as the user. In some examples, a sender inbox may include a sender portal within an integrated communication system that facilitates communication, via one or more APIs, between the sender and one or more users of the integrated communication system. By way of example, in a clinical prediction domain, a sender inbox may include a component of a patient profile that enables a patient to compose and provide messages to one or more users associated with the patient.

In some embodiments, the term “user” refers to an entity that receives a message from a sender. A user may be any automated, synthetic, or real entity that provides a service in a prediction domain. For instance, a user may be an automated agent that is triggered to perform one or more automated actions in response to a message. In addition, or alternatively, a user may include a human actor that provides a service (e.g., a professional service, etc.) for a user. By way of example, in a clinical prediction domain, a user may be a healthcare provider that may perform one or more clinical actions (e.g., updating a prescription, scheduling a follow-up visit, analyzing lab results, providing consultation notes, etc.) on a patient's behalf.

In some embodiments, the term “user identifier” refers to a data entity that identifies a user. A user identifier, for example, may include a numeric, alpha-numeric, and/or any other value that identifies a particular entity within a prediction domain. By way of example, a user identifier may include an assigned code, a name, a username, an email address, a phone number, and/or the like. In some examples, a user identifier may include an encoded representation (e.g., hash, etc.) of an identifiable information for a user.

In some embodiments, the term “user inbox” refers to a portion of memory that receives and stores a plurality of messages for a user. A user inbox, for example, may include a portion of a digital communication application (e.g., an information manager software system, etc.) that stores messages received from one or more senders, facilitates the composition of new messages to a sender, and/or provides messages from the user to one or more recipients, such as the sender. In some examples, a user inbox may include a user portal within an integrated communication system that facilitates communication, via one or more APIs, between the user and one or more senders of the integrated communication system. By way of example, in a clinical prediction domain, a user inbox may include a component of a provider profile that enables a healthcare provider to digitally interact with one or more of their patients. For example, in a clinical context, a user inbox may include a clinician inbox, as driven through the Electronic Health Record (EHR) task inbox.

In some embodiments, the term “domain knowledge index” refers to a data structure that links data from a plurality of disparate data sources associated with a prediction domain. A domain knowledge index, for example, may integrate two component indices through a plurality of shared embedding codes. The two component indices may include a domain-specific index (e.g., a domain data index) and an enterprise-specific index (e.g., historical data index) to increase intelligence of integrated systems by enabling the specific understanding of a message within the context of a sender's current situation.

In some embodiments, the domain knowledge index is integrated with a machine learning semantic search framework to automate the processing and augmentation of a message received in a user inbox. Unlike traditional knowledge indices, the domain knowledge index provides consistent intelligence to a multi-stage automated process by connecting robust terminology data sources (e.g., a domain data index) to manage the semantic understanding of a message and ensure a consistent use of concepts across each stage of the multi-stage automated process.

In some embodiments, the term “domain data index” refers to a portion of the domain knowledge index. A domain data index may include a plurality of domain data entities that are reflective of one or more different terminologies within a prediction domain. Each domain data entity, for example, may include a shared embedding code and describe a particular concept within the prediction domain. In some examples, each domain data entity may correspond to an automated task category.

In some embodiments, the term “domain data source” refers to a disparate data source that stores, manages, and/or the like, domain data associated with the domain data index. In some examples, the domain data index may aggregate data from a plurality of domain data sources associated with a prediction domain. Each of the domain data sources may describe terminology associated with the particular prediction domain. As an example, in a clinical prediction domain, the plurality of data sources may include an RXNorm, LOINC, SNOWMED, ICD 10, Value sets, and/or the like. In some examples, a plurality of domain data entities may be aggregated from the domain data sources and assigned a shared embedding code that is synthesized across one or more historical data sources of the domain knowledge index.

In some embodiments, the term “shared embedding code” refers to a value that represents a shared representation of a data entity. A shared embedding code may include a numeric, alpha-numeric, and/or any other value that identifies a concept within a prediction domain. In some examples, a shared embedding code may be an embedding of a standardized textual description of the concept. For example, a shared embedding code may be generated for each of a plurality of domain data entities by inputting a textual description (e.g., a name, one or more textual attributes, etc.) to an encoding model, such as a pretrained BERT encoder, and/or the like, to receive a shared embedding code for the domain data entity. In some examples, a plurality of shared embedding codes may be shared, by the domain knowledge index, across a plurality of component indices to link related concepts (e.g., using different textual descriptions to refer to the same concept, etc.) using a shared identifier.

In some embodiments, the term “historical data index” refers to a portion of the domain knowledge index. A historical data index may include a plurality of historical data entities that are reflective of one or more attributes of an entity cohort within a prediction domain. Each historical data entity, for example, may include an entity attribute, an entity identifier (e.g., a sender identifier, etc.), and/or a shared embedding code corresponding to the attribute. In some examples, the plurality of historical data entities may be aggregated from a plurality of historical data sources accessible to an enterprise. For instance, in a clinical prediction domain, the plurality of historical data entities may be aggregated from a plurality of electronic health records (EHRs) maintained by an enterprise for a cohort of affiliated patients.

In some embodiments, the term “historical data source” refers to a disparate data source that stores, manages, and/or the like, domain data associated with the historical data index. A historical data source may describe recorded attributes associated with a particular prediction domain. As an example, in a clinical prediction domain, a historical data source may include patient clinical history repositories that describe one or more patient demographics, clinical encounters, clinical results, medications, procedures, and/or the like.

As described herein, the domain knowledge index may integrate the domain data index and the historical data index to inform a machine learning semantic search framework on the context of a sender's history while processing a message from the sender.

In some embodiments, the term “machine learning semantic search framework” refers to a data entity that describes parameters, hyper-parameters, and/or defined operations of a rules-based and/or machine learning model (e.g., model including at least one of one or more rule-based layers, one or more layers that depend on trained parameters, coefficients, and/or the like). A machine learning semantic search framework may include any type of model configured, trained, and/or the like to perform one or more operations of a multi-stage automated process, as described herein. A machine learning semantic search framework may include one or more of any type of machine learning model including one or more supervised, unsupervised, semi-supervised, and/or reinforcement learning models. In some embodiments, the machine learning semantic search framework may include multiple models configured to perform one or more different stages of a multi-stage automated process.

In some examples, the machine learning semantic search framework may be integrated with the domain knowledge index to build an automated messaging management solution using a pipeline of machine learning and natural language understanding models integrated into a singular terminology service to ensure semantic consistency across the framework. The machine learning semantic search framework, for example, may include a plurality of connected components that each reference the domain knowledge index to perform one or more operations of a multi-stage automated process.

A first component, a semantic searching component, may be configured to perform a semantic searching function using one or more natural language processing and/or natural language understanding models that leverage the domain knowledge index to identify the precise nomenclature and terms to represent the concept that the message originator had intended. In addition, or alternatively, a second component, an automated task resolution component, may be configured to perform an automated task associated with an automated task category using the domain knowledge index to identify the automated task category. In this way, the integration of the machine learning semantic search framework and the domain knowledge index may ensure sematic consistency from the initial intent understanding of a message to the processing of domain information, through a rules engine, and finally, the communicating a message response for the message.

In some examples, a semantic searching component of the machine learning semantic search framework may include a message acquisition module and a message understanding module. The message acquisition module may acquire a message from a sender by rerouting the message, via an API, from a user inbox to the message understanding module. In some examples, the machine learning semantic search framework may be configured to process the message prior to a user viewing the message.

The message understanding module may process the message, using one or more natural language processing and/or natural language understanding models and the domain knowledge index, to identify a semantic intent classification and/or one or more shared embedding codes representing an intent of the message. For example, the message understanding module may include a semantic search algorithm, which is enhanced by the domain knowledge index, to identify appropriate terminologies and codes to accurately represent a message's intent. These may then be used to search against historical data entities associated with a sender of the message to identify terminologies and codes that are tailored to a sender's history.

In some examples, the message understanding module may include a first portion that includes an encoding portion and an encoding comparison portion that are collectively configured to rank a plurality of domain data entities with respect to a message.

The encoding portion, for example, may include a machine learning encoding model, such as a pretrained BERT encoder, and/or the like, that is configured to generate a semantic embedding for a message based on the message text data and/or a portion of the message text data. For instance, the semantic embedding may include an embedding of the message text data. In addition, or alternatively, the encoding portion may include a named entity recognition model (e.g., dictionary-based, rules-based, machine learning-based, etc.) configured to extract one or more domain-specific terms from the message text data and the semantic embedding may include an embedding of the one or more domain-specific terms.

The encoding comparison portion may rank which of the plurality of domain data entities from the domain data index aligns to the message with the highest degree of confidence. For example, the plurality of domain data entities may be ranked based on an embedding comparison between the semantic embedding and the shared embedding codes respectively corresponding to the plurality of domain data entities. By way of example, the embedding comparison may include a cosine distance similarity, and/or the like. In some examples, encoding comparison portion may identify a semantic class corresponding to the message based on the ranked shared embedding codes.

In some examples, the message understanding module may include a second portion configured to identify a shared embedding code from the semantic class that is tailored to the sender of the message. The second portion, for example, may include a query logic that is configured to execute a plurality of queries to the historical data index to identify a shared embedding code within the semantic class that corresponds to the sender of the message. In this manner, a semantic embedding code may be identified for a message that is both semantically relevant and personalized to a user.

In this way, by combining the domain and historical data indices into the domain knowledge index, a message understanding module may filter through a plurality of relevant concept to identify a concept that is most relevant with respect to a message and the context in which the message is provided. By way of example, with reference to a clinical prediction domain, the domain knowledge index and the message understanding module may be able to identify approximately 547 possible Ozempic codes that could align with a message based only on the message text data and the domain data index. Using the connected historical data index, the message understanding module may be able to map the medication up to a medication class of ‘Antidiabetic Medication’ and search against a patient's active medications, finding an active prescription for Ozempic with dosage information enabling it to identify a single code out of the 547 possible codes to represent a message requesting a refill of a generic medication. Without the domain knowledge index, for example, the message understanding module may be limited to the generic code to represent Ozempic rather than the personalized code descriptive of the sender's actual intent.

In some embodiments, the message understanding module may include a third portion that is configured to identify a semantic intent classification for a message based on the shared embedding code and the message text data. The third portion, for example, may include a large language model, such as a generative pre-trained transformer, and/or the like, that is configured to generate a semantic intent classification in response to a model prompt and information from a message. The large language model, for example, may receive a model prompt that includes (i) a prompt requesting a semantic intent classification from one or more predefined semantic intent classifications, (ii) the shared embedding code, and/or (iii) the message text data from the message. By way of example, in a clinical prediction domain, an example model prompt may ask if the message text data is requesting a medication renewal and if so, whether the large language model may identify the medication requested. In some examples, the large language model may output an affirmative semantic intent classification and/or an alternative semantic intent classification for the message based on the model prompt.

In some examples, the semantic searching component may provide the identified terminologies and codes to the automated task resolution component to perform an automated task based on the message's intent. The automated task resolution component, for example, may include a rules engine that leverages the domain knowledge index to increase the overall solution intelligence by removing the opportunity for misalignment in domain semantics. In some examples, this is enforced at a granular level by coding for this solution using Clinical Quality Language (CQL), which requires alignment to terminology and standardization.

In some embodiments, the term “coded model output” refers to an output of at least a portion of a machine learning semantic search framework. A coded model output, for example, may include a semantic intent classification and/or a shared embedding code corresponding a message. A coded model output may depend on the prediction domain. As one example, with reference to a clinical prediction domain, a coded model output may be reflective of a patient's intent (e.g., a refill request, etc.) and a medication, condition, and/or the like, that is referenced by the patient.

In some embodiments, the term “semantic embedding” refers to an encoded representation of at least a portion of the message text data within a message. A semantic embedding, for example, may include an embedded representation of a message text data and/or one or more terms extracted from the message text data, as described herein.

In some embodiments, the term “semantic class” refers to a group of data entities within at domain data index. A semantic class, for example, may be a generic data entity that corresponds to a plurality of specific data entities within a prediction domain. By way of example, in a clinical prediction domain, a semantic class may be a generic medication class (e.g., without dosage information, etc.) and a specific data entity corresponding to the semantic class may be specific dosage, type, and intake of the generic medication class.

In some embodiments, the term “semantic intent classification” refers to a portion of a coded model output that describes a predicted intent of a message. A semantic intent classification, for example, may identify a task requested by the message.

In some embodiments, the term “model prompt” refers to a generative model prompt for instructing a large language model to generate a semantic intent classification. For example, a large language model may be prompted with a text prompt to add context to message text data. The additional context may include a predefined template that corresponds to a shared embedding code. For example, the predefined template may include a predefined textual description and/or request that identifies one or more automated task categories that may correspond to a shared embedding code. In some examples, the predefined template may include one or more natural language instructions answering a question with respect to the shared embedding code. By way of example, a predefined template may state “Is the [message text data] requesting a refill for [shared embedding code].”

A model prompt may be dynamically configured based on a shared embedding code. For instance, one of one or more predefined templates may be identified based on the shared embedding code and the identified template may be modified, using the message text data and/or the shared embedding code, to configure the model prompt.

In some embodiments, the term “automated task category” refers to a predefined classification that corresponds to an automated task. An automated task category may include an actionable task for responding a message. The actionable task may include a set of logical operations that may be performed to automatically respond to a message. In some examples, the set of logical operations may be defined by a set of query assertions.

An automated task category may depend on the prediction domain. For example, in a clinical prediction domain, an automated task category may include one of a series of tasks that are provided to a healthcare provider, by way of their user inbox in an EHR system, to perform a clinical and/or administrative process. Each task may be instructed, authorized, and/or requested by a variety of senders, including other healthcare providers, patients, an insurance system, and/or the like, by providing a message to the user inbox. Each task causes burden on a user that varies based on the nature of the task. Burden, for example, is a function of message volume and effort to address. In some examples, to reduce overall burden, a subset of task types is automated and categorized as automated task categories. Each automated task category may include a repeatable, rules-based process to standardize solving for a particular task. For example, continuing the clinical prediction domain example, an automated task category may include a medication renewal request that may be responded to by executing a set of query assertions designed to gathering relevant clinical facts from a patient's record, compare the clinical facts to standard medication renewal request protocols, and/or surface the results of the protocol analysis to the user in a user-friendly and easily digestible way.

In some embodiments, the term “set of query assertions” refers to decision logic for executing an automated task of an automated task category. The set of query assertions may include one or more logic statements, each describing a computer-interpretable query for a shared embedding code. In some examples, a set of query assertions may include a plurality of conditional queries. Each conditional query may include a query and a conditional logic for moving to a subsequent conditional query of the set of query assertions. In some examples, a query of a conditional query may include query logic for initiating a query to the domain knowledge index. The query logic, for example, may be executable by a query system to initiate a query to a historical data source integrated with the domain knowledge index and, in response to the query, receive a query response from the historical data source. The query logic, for example, may include an executable instruction for retrieving a particular data value type from a record accessible to a query system. A conditional logic of the conditional query may define an action in response to the query response. The action, for example, may define a subsequent conditional query of the set of query assertions. The set of query assertions may terminate with a predictive response for a message associated with a shared embedding code.

A set of query assertions may be specific to a prediction domain and/or the automated task categories defined within the prediction domain. For example, for a medication renewal request in a clinical prediction domain, the set of query assertions may include a standardized rules-based protocol that guides an automated process for identifying specific fields in a patient's chart and comparing them to the same fields listed in the protocol to assess if the medication is appropriate for refill. As an example, for the renewal of a Diuretic medication, each time a Diuretic medication renewal is requested, an automated process may be performed to review the patient's chart to assess (a) the date of their last visit, (b) who the visit was with, (c) what lab tests were completed, (d) if they have had an electrolyte lab result in the last 6 months, and (e) what the value of the electrolyte lab was.

In order to inform a user for easier decision making with respect to an automated task category, operational protocols for an automated task category (e.g., the Diuretic example above) may be converted into executable logic (e.g., a set of query assertions) where each criterion of the operational protocol is converted to a condition query for evidence and routing logic to another query or an end result of the protocol. By way of example, using the Diuretic medication renewal example, the set of query assertions may include a first conditional query to request evidence of whether the patient has had an office visit in the last 12 months, a second conditional query to request evidence of whether the patient has had either a potassium or sodium test in the last 6 months, and/or the like. The inclusion of the domain knowledge index enables semantic consistency between the shared embedding code of the message and the set of query assertions. This may be further ensured by authoring the rules in Clinical Quality Language standard. By using this language, the terminology evaluation may be tied to the domain knowledge index thus enforcing the semantic consistency, ensuring improved overall solution intelligence. In addition, this approach allows for each rule reviewed and signed off by appropriate stakeholders with clinical oversight responsibilities with the knowledge that all terminology references are semantically accurate.

In some embodiments, the term “query” refers to a data entity that describes a request for information from a data source. A query, for example, may include executable logic that is executable to receive information from a data source.

In some embodiments, the term “query response” refers to a data entity that describes information from a data source that is received in response to a query.

In some embodiments, the term “predicted response” refers to a data entity that describes an anticipated response for a user that receives a message. A predicted response may include each of the query responses and a predicted action of a set of query assertions. For example, once the set of query assertions is executed, a list of query responses may be received that provides data for proactively responding to a message. For example, in the Diuretic example, the query responses may indicate that a patient has not had a potassium test in the past 6 months and has not had an office visit with their primary care doctor in the past 12 months, which calls for a predicted action of a conditional refill for the next 100 days. In some examples, the original message may be augmented with this information and then rerouted to a user inbox.

In some embodiments, the term “predicted action” refers to a data entity that describes an anticipated action for handling a message. By way of example, in the Diuretic example, three predicted actions are defined, including (i) if all conditions are met and no new health conditions have presented themselves, the clinician may renew the Diuretic medication in question for 6 months, (ii) if some of the conditions have not been met, the clinician may refill for a shorter duration, 100 days, and contact the patient to let them know what they need to do to renew again, and (iii) the clinician may end the prescription altogether, not renewing but informing the patient they no longer need the prescription.

In some embodiments, the term “automated response” refers to a data entity that describes an anticipated action for a sender that provides a message. For example, an automated response may include an automatic notification that is returned to a sender of a message. For instance, if a message reflects a need to be informed of a future event related to the message, an automated response may be returned to the sender that identifies the future event. In some examples, the automated response may be based on the shared embedding code, a semantic intent classification, one or more query responses, and/or a predicted action. For example, using the information received during the processing of the message, a semantic understanding of the intent of the message may be derived and additional actions may be identified to enable the sender to fulfill a message's request. These actions, for example, may include actions to address one or more of the set of query assertions for an identified automated task category (e.g., scheduling a lab visit for a test, etc.).

As a clinical example, an automated response may identify a scheduled appointment for a gap in care that may be provided using consumer friendly terminologies which will be aligned to the original clinical intent of the request through the inclusion of the domain knowledge index. Whatever the gap is, the techniques of the present disclosure allow for the identification of it, which allows for the solution to reach out to the patient to inform them of the need via email, SMS text, or even Interactive Voice Response phone call if needed. In some examples, the form of the automated response may be driven by patient preferences in the EHR.

### IV. OVERVIEW

Various embodiments of the present disclosure provide automated message processing techniques that improve traditional communication systems, such as those that interface between a user and a plurality of requesting entities. To do so, some embodiments of the present disclosure provide a machine learning semantic search framework that is integrated with a domain knowledge index and configured to execute an automated task before the message is viewed by a user. To do so, the machine learning semantic search framework may leverage a sequence of machine learning models, rule-based techniques, and a set of assertions to identify a semantic intent of the message and proactively initiate a message response based on the message's semantic intent. The machine learning semantic search framework may process a message using a multi-stage message acquisition, understanding, and response approach in which a message is intercepted and then sequentially processed to augment the message before it is delivered to an end user. By doing so, the machine learning semantic search framework and the domain knowledge index may be leveraged to improve the performance of a computer with respect to various communication functionalities, including user inbox management, predictive response generation, among others. This, in turn, enables an improved communication functionalities that directly address technical challenges within the realm of electronic messaging, such as overloaded memory resources for storing message backlogs, delayed response times, among others.

Some embodiments of the present disclosure provide a domain knowledge index that enables a terminology service to connect related concepts within a domain. The domain knowledge index, for example, may include a plurality of semantically constructed shared embedding codes that are respectively assigned to a plurality of meaningful concepts defined by a various terminologies used within a domain. The shared embedding codes enable seamless transition between different terminologies used within the prediction domain. By doing so, user friendly terminology, such as the terminology within a message and expected in a message response, may be mapped to precisely defined terms based on the semantic relevance of the user-friendly terminology to the precisely defined terms. This allows for semantic consistency across a multi-stage process that involves action by both users and automated agents. By doing so, the domain knowledge index enables a multi-stage messaging process that may transition between stages without information loss. This improves the accuracy and reliability of resulting predictions as well as the processing speed of arriving at the predictions.

Moreover, the domain knowledge index may combine private enterprise data with public domain data to improve the accuracy and depth of the precisely defined terms mapped to user-friendly terminology. For instance, the private enterprise data may include information that is tailored to a message's sender, whereas the public domain data may be generalized with respect to a particular sender and may define a hierarchy of terms that range in both predictive significance within the domain and relevance to a sender. By connecting both types of data sources, the domain knowledge index enables a semantic search process that optimizes the identification of terms that are both predictively significance and relevant to a message's sender.

In some embodiments, the present disclosure provides a machine learning semantic search framework that is integrated with the domain knowledge index to provide an improved message handling process. The machine learning semantic search framework may implement a multi-stage message handling process that sequentially processes a message to generate and augment the message with a predicted query response before the message is viewed by a user. By doing so, the machine learning semantic search framework may reduce the use of computing resources required for communication systems by proactively processing messages before they are stored within a user inbox. This reduces repetitive tasks that traditionally extend the processing time of messages.

The machine learning semantic search framework may include multi-stages including, a data gathering and standardization stage, a data alignment analysis, a data packaging stage, and a response stage. At each stage, the machine learning semantic search framework may reference the domain knowledge index to maintain a semantic consistency between intermediate output. By doing so, the machine learning semantic search framework may implement a new machine learning pipeline that uniquely solves several technical challenges in prediction data analysis, data storage, and inbox management.

Examples of technologically advantageous embodiments of the present disclosure include the machine learning semantic search framework and the domain knowledge index, among other aspects of the present disclosure. Other technical improvements and advantages may be realized by one of ordinary skill in the art.

### V. EXAMPLE SYSTEM OPERATIONS

As indicated, various embodiments of the present disclosure make important technical contributions to communication interfaces and computer interpretation techniques by addressing several technical challenges in prediction data analysis, data storage, and inbox management. In particular, systems and methods are disclosed herein that implement machine learning semantic searching and data storage techniques to improve message interpretation and handling in communication interfaces. By doing so, communication interfaces may be improved to proactively handle and augment messages before the message is viewed. This, in turn, improves the functionality of various communication technologies by reducing memory and processing resources traditionally devoted to handling message backlogs.

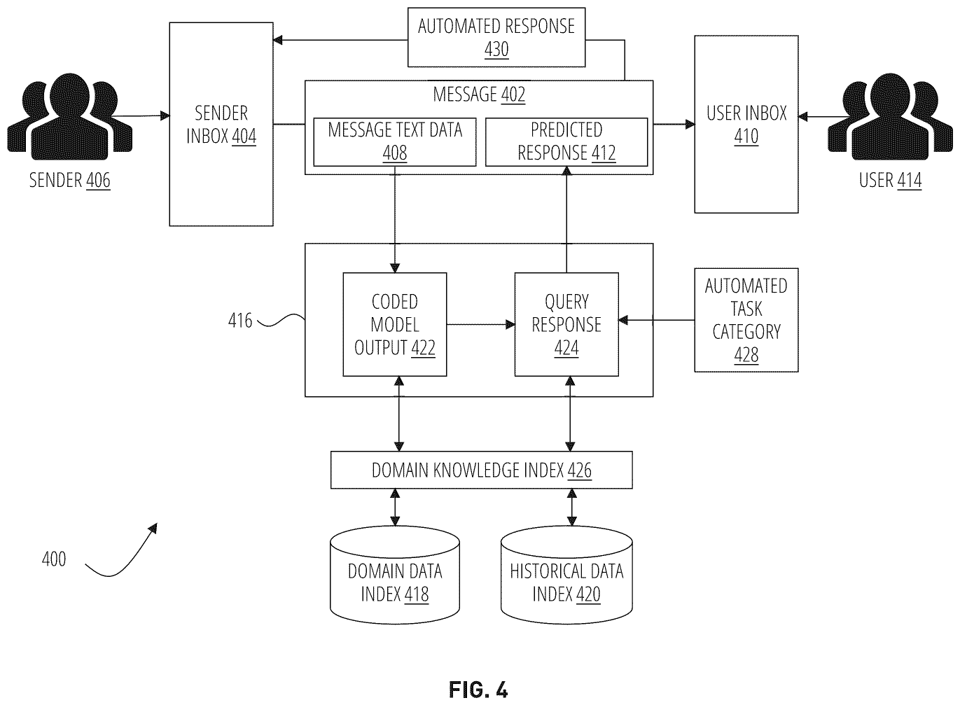

FIG. 4 is a dataflow diagram 400 showing example data structures and modules for handling a message in accordance with some embodiments discussed herein. The dataflow diagram 400, for example, illustrates a multi-stage message acquisition and response approach for intercepting a message 402 directed to a user inbox 410, intelligently identifying a semantic intent of the message 402 based on message text data 408 of the message 402, and augmenting the message 402 with a predicted response 412 before the message 402 is delivered to the user inbox 410. As described herein, the semantic intent of a message 402 may be identified and handled through a multi-stage automated process that is enabled by machine learning semantic search framework 416 integrated with a domain knowledge index 426. The machine learning semantic search framework 416, for example, may leverage the domain knowledge index 426 to process the message 402 across a plurality of stages while maintaining a consistent semantic understanding of the message 402. In this way, the machine learning semantic search framework 416 and the domain knowledge index 426 enables an improved message handling process that is capable of execution in real time as a message 402 is routed between a sender inbox 404 and a user inbox 410.

In some embodiments, a message 402 is identified that is directed to a user inbox 410. The message 402 may be associated with an automated task category 428 of a plurality of different automated task categories. The message 402 may include message text data 408 reflective of the automated task category 428. In addition, or alternatively, the message 402 may include a sender identifier.

In some embodiments, the message 402 is a data entity that describes a communication between two computing devices. A message 402, for example, may include a textual communication that is provided to a user 414 from a sender 406. By way of example, a message 402 may include an email, short message service text, a call transcript, and/or another form of communication between a sender 406 and a user 414. A message 402 may include message text data 408 and/or contextual data associated with the sender 406 of the message 402. The message text data 408, for example, may be reflective of information, a request, and/or the like that is provided by the sender 406 to the user 414 via the message 402. As an example, with reference to a clinical domain, a sender 406 may be a patient and a message 402 may state “Hello doctor, I'm almost out of my Ozempic medication, may you please send a refill to my pharmacy, but please make it for only one month as I cannot afford a 90 refill.”

In some embodiments, a message 402 is routed, via one or more APIs, from a sender 406 to a user inbox 410 to deliver a communication to the user 414. In some examples, a custom API is used to extract the message 402 before it is reviewed by a user 414. The message 402 may be extracted to perform one or more message augmentation techniques of the present disclosure. The message augmentation techniques, for example, may include identifying information, such as the message text data 408, and/or the like, that is associated with the message 402, receiving additional information based on the message text data 408, and/or applying a set of query assertions to the message 402 to receive the predicted response 412.

In some embodiments, the message text data 408 is a textual segment of a message 402. The message text data 408 may include a textual representation of information provided by the message 402. For instance, message text data 408 may be reflective of a sender's intent, query, notification, and/or the like. In some examples, message text data 408 may describe a request for the performance of an action by the user 414. By way of example, message text data 408 may be reflective of an automated task category 428.

In some embodiments, a sender 406 is an entity that provides a message 402 to a user 414. A sender 406 may be any automated, synthetic, and/or real entity that requests a service in a prediction domain. For instance, a sender 406 may be an automated agent that is triggered to provide a message 402 based on one or more triggering criteria (e.g., an event-based alert, a time-based alert, etc.). In addition, or alternatively, a sender 406 may include a human actor that provides a natural language message to a user 414. By way of example, in a clinical prediction domain, a sender 406 may be a patient that provides a message 402 to a healthcare provider to request a clinical action on the patient's behalf. In some examples, the sender 406 may be an automated agent that provides a message 402 to initiate the clinical action on the patient's behalf.

In some embodiments, a sender identifier is a data entity that identifies a sender 406. A sender identifier, for example, may include a numeric, alpha-numeric, and/or any other value that identifies a particular entity within a prediction domain. By way of example, a sender identifier may include an assigned code, a name, a username, an email address, a phone number, and/or the like. In some examples, a sender identifier may include an encoded representation (e.g., hash, etc.) of identifiable information for a sender 406.

In some embodiments, a sender inbox 404 is a portion of memory that receives and stores a plurality of messages for a sender 406. A sender inbox 404, for example, may include a portion of a digital communication application (e.g., an information manager software system, etc.) that stores messages received by a sender 406, facilitates the composition of new messages from the sender 406, and/or provides messages from the sender 406 to one or more recipients, such as the message 402 to the user 414. In some examples, a sender inbox 404 may include a sender portal within an integrated communication system that facilitates communication, via one or more APIs, between the sender 406 and one or more users of the integrated communication system. By way of example, in a clinical prediction domain, a sender inbox 404 may include a component of a patient profile that enables a patient to compose and provide messages to one or more users associated with the patient.

In some embodiments, a user 414 is an entity that receives a message 402 from a sender 406. A user 414 may be any automated, synthetic, or real entity that provides a service in a prediction domain. For instance, a user 414 may be an automated agent that is triggered to perform one or more automated actions in response to a message 402. In addition, or alternatively, a user 414 may include a human actor that provides a service (e.g., a professional service, etc.) for a user 414. By way of example, in a clinical prediction domain, a user 414 may be a healthcare provider that may perform one or more clinical actions (e.g., updating a prescription, scheduling a follow-up visit, analyzing lab results, providing consultation notes, etc.) on a patient's behalf.

In some embodiments, the user identifier is a data entity that identifies a user 414. A user identifier, for example, may include a numeric, alpha-numeric, and/or any other value that identifies a particular entity within a prediction domain. By way of example, a user identifier may include an assigned code, a name, a username, an email address, a phone number, and/or the like. In some examples, a user identifier may include an encoded representation (e.g., hash, etc.) of an identifiable information for a user 414.

In some embodiments, a user inbox 410 is a portion of memory that receives and stores a plurality of messages for a user 414. A user inbox 410, for example, may include a portion of a digital communication application (e.g., an information manager software system, etc.) that stores messages received from one or more senders, facilitates the composition of new messages to a sender 406, and/or provides messages from the user 414 to one or more recipients, such as the sender 406. In some examples, a user inbox 410 may include a user portal within an integrated communication system that facilitates communication, via one or more APIs, between the user 414 and one or more senders of the integrated communication system. By way of example, in a clinical prediction domain, a user inbox 410 may include a component of a provider profile that enables a healthcare provider to digitally interact with one or more of their patients. For example, in a clinical context, a user inbox 410 may include a clinician inbox, as driven through an EHR task inbox.

In some embodiments, a coded model output 422 is generated for the message 402 using a machine learning semantic search framework 416. The coded model output 422 may be generated based on the message text data 408 and the domain data index 418. The coded model output 422 may include a semantic intent classification and/or a shared embedding code. In some examples, the shared embedding code is one of a plurality of shared embedding codes. The domain knowledge index 426 may include a historical data index 420 and a domain data index 418. The historical data index 420 may include a plurality of historical data entries that is from one or more historical data sources and respectively corresponds to the plurality of shared embedding codes. The domain data index 418 includes a plurality of domain data entries that is from one or more domain data sources and respectively corresponds to the plurality of shared embedding codes. In some examples, the shared embedding codes are previously generated, using an encoding portion of the machine learning semantic search framework 416, for each of the plurality of domain data entity of the domain data index 418.

In some embodiments, a shared embedding code is a value that represents a shared representation of a data entity. A shared embedding code may include a numeric, alpha-numeric, and/or any other value that identifies a concept within a prediction domain. In some examples, a shared embedding code may be an embedding of a standardized textual description of the concept. For example, a shared embedding code may be generated for each of a plurality of domain data entities associated with a domain knowledge index 426 by inputting a textual description (e.g., a name, one or more textual attributes, etc.) to an encoding model, such as a pretrained BERT encoder, and/or the like, to receive a shared embedding code for the domain data entity. In some examples, a plurality of shared embedding codes may be shared, by the domain knowledge index 426, across a plurality of component indices to link related concepts (e.g., using different textual descriptions to refer to the same concept, etc.) using a shared identifier.

In some embodiments, the domain knowledge index 426 is a data structure that links data from a plurality of disparate data sources associated with a prediction domain. A domain knowledge index 426, for example, may integrate two component indices through a plurality of shared embedding codes. The two component indices may include a domain-specific index (e.g., a domain data index 418) and an enterprise-specific index (e.g., historical data index 420) to increase intelligence of integrated systems by enabling the specific understanding of a message 402 within the context of a sender's current situation.

In some embodiments, the domain knowledge index 426 is integrated with a machine learning semantic search framework 416 to automate the processing and augmentation of a message 402 received in and/or directed to a user inbox 410. Unlike traditional knowledge indices, the domain knowledge index 426 provides consistent intelligence to a multi-stage automated process by connecting robust terminology data sources (e.g., a domain data index 418) to manage the semantic understanding of a message 402 and ensure a consistent use of concepts across each stage of the multi-stage automated process.

In some embodiments, the domain data index 418 is a portion of the domain knowledge index 426. A domain data index 418 may include a plurality of domain data entities that are reflective of one or more different terminologies within a prediction domain. Each domain data entity, for example, may include a shared embedding code and describe a particular concept within the prediction domain. In some examples, each domain data entity may correspond to one or more automated task categories.

In some embodiments, the historical data index 420 is a portion of the domain knowledge index 426. A historical data index 420 may include a plurality of historical data entities that are reflective of one or more attributes of an entity cohort within a prediction domain. Each historical data entity, for example, may include an entity attribute, an entity identifier (e.g., a sender identifier, etc.)), and/or a shared embedding code corresponding to the attribute. In some examples, the plurality of historical data entities may be aggregated from a plurality of historical data sources accessible to an enterprise. For instance, in a clinical prediction domain, the plurality of historical data entities may be aggregated from a plurality of EHRs maintained by an enterprise for a cohort of affiliated patients.

In some embodiments, the machine learning semantic search framework 416 is a data entity that describes parameters, hyper-parameters, and/or defined operations of a rules-based and/or machine learning model (e.g., model including at least one of one or more rule-based layers, one or more layers that depend on trained parameters, coefficients, and/or the like). A machine learning semantic search framework 416 may include any type of model configured, trained, and/or the like to perform one or more operations of a multi-stage automated process, as described herein. A machine learning semantic search framework 416 may include one or more of any type of machine learning model including one or more supervised, unsupervised, semi-supervised, and/or reinforcement learning models. In some embodiments, the machine learning semantic search framework 416 may include multiple models configured to perform one or more different stages of a multi-stage automated process.

In some examples, the machine learning semantic search framework 416 may be integrated with the domain knowledge index 426 to build an automated messaging management solution using a pipeline of machine learning and natural language understanding models integrated into a singular terminology service to ensure semantic consistency across the framework. The machine learning semantic search framework 416, for example, may include a plurality of connected components that each reference the domain knowledge index 426 to perform one or more operations of a multi-stage automated process.

In some embodiments, the coded model output 422 is an output of at least a portion of a machine learning semantic search framework 416. A coded model output 422, for example, may include a semantic intent classification and/or a shared embedding code corresponding a message 402. A coded model output 422 may depend on the prediction domain. As one example, with reference to a clinical prediction domain, a coded model output 422 may be reflective of a patient's intent (e.g., a refill request, etc.) and a medication, condition, and/or the like, that is referenced by the patient in the message 402.

In some embodiments, the automated task category 428 is identified based on the semantic intent classification and/or the shared embedding code of the coded model output 422.

In some embodiments, the automated task category 428 is a predefined classification that corresponds to an automated task. An automated task category 428 may include an actionable task for responding to a message 402. The actionable task may include a set of logical operations that may be performed to automatically respond to a message 402. In some examples, the set of logical operations may be defined by a set of query assertions.

An automated task category 428 may depend on the prediction domain. For example, in a clinical prediction domain, an automated task category 428 may include one of a series of tasks that are provided to a healthcare provider, by way of their user inbox 410 in an EHR system, to perform a clinical and/or administrative process. Each task may be instructed, authorized, and/or requested by a variety of senders, including other healthcare providers, patients, an insurance system, and/or the like, by providing a message 402 to the user inbox 410. Each task causes burden on a user 414 that varies based on the nature of the task. Burden, for example, is a function of message volume and effort to address. In some examples, to reduce overall burden, a subset of task types is automated and categorized as automated task categories. Each automated task category may include a repeatable, rules-based process to standardize solving for a particular task. For example, continuing the clinical prediction domain example, an automated task category 428 may include a medication renewal request that may be responded to by executing a set of query assertions designed to gathering relevant clinical facts from a patient's record, compare the clinical facts to standard medication renewal request protocols, and/or surface the results of the protocol analysis to the user 414 in a user-friendly and easily digestible way.

In some embodiments, a predicted response 412 is generated for the message 402 using the domain knowledge index 426. The predicted response 412 may be generated based on the automated task category 428. In some examples, the automated task category 428 includes a set of query assertions that corresponds to a particular task for a shared embedding code. The predicted response 412 may be generated by generating a sequence of queries for the historical data index 420 based on the set of query assertions, executing the sequence of queries to receive a plurality of query responses 424, and generating the predicted response 412 based on the plurality of query responses 424. In some examples, the predicted response 412 includes a text description reflective of the semantic intent classification and the shared embedding code, the plurality of query responses 424, and a predicted action for the message 402 that is based on the plurality of query responses 424 and the set of query assertions.

In some embodiments, a query is a data entity that describes a request for information from a data source. A query, for example, may include executable logic that is executable to receive information from a data source. In some embodiments, the query responses 424 are data entities that describe information from a data source that is received in response to a query.

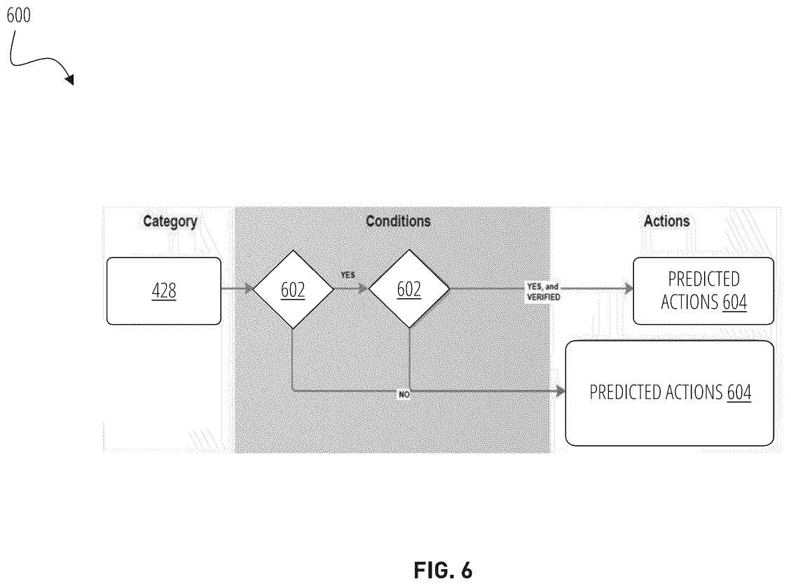

In some embodiments, the predicted response 412 is a data entity that describes an anticipated response for a user 414 that receives a message 402. A predicted response 412 may include each of the query responses 424 and a predicted action of a set of query assertions. For example, once the set of assertions is executed, a list of query responses 424 may be received that provides data for proactively responding to a message 402. For example, in a Diuretic example illustrated with reference to FIG. 6, the query responses 424 may indicate that a patient has not had a potassium test in the past 6 months and has not had an office visit with their primary care doctor in the past 12 months, which calls for a predicted action of a conditional refill for the next 100 days. In some examples, the message 402 may be augmented with this information and then routed to a user inbox 410.

In some embodiments, the message 402 is modified with the predicted response 412. In some examples, a sender identifier may identified that is associated with the message 402. An automated response 430 may be provided to the sender inbox 404 associated with a sender 406 of the message 402 based on the sender identifier and the coded model output 422.

In some embodiments, the automated response 430 is a data entity that describes an anticipated action for a sender 406 that provides a message 402. For example, an automated response 430 may include an automatic notification that is returned to a sender 406 of a message 402. For instance, if a message 402 reflects a need to be informed of a future event related to the message 402, an automated response 430 may be returned to the sender 406 that identifies the future event. In some examples, the automated response 430 may be based on the shared embedding code, a semantic intent classification, one or more query responses 424, and/or a predicted action. For example, using the information received during the processing of the message 402, a semantic understanding of the intent of the message 402 may be derived and additional actions may be identified to enable the sender 406 to fulfill a message's request. These actions, for example, may include actions to address one or more of the set of assertions for an identified automated task category 428 (e.g., scheduling a lab visit for a test, etc.).

As a clinical example, an automated response 430 may identify a scheduled appointment for a gap in care that may be provided using consumer friendly terminologies which will be aligned to the original clinical intent of the request through the inclusion of the domain knowledge index 426. Whatever the gap is, the techniques of the present disclosure allow for the identification of it, which allows for the solution to reach out to the patient to inform them of the need via email, SMS text, or even Interactive Voice Response phone call if needed. In some examples, the form of the automated response may be driven by patient preferences in the EHR.

In this way, a message 402 may be intercepted enroute to a user inbox 410, processed using a multi-stage automated process, and automatically handled before a user 414 receives the message 402. The multi-stage automated process may be performed by the machine learning semantic search framework 416, which be integrated with the domain knowledge index 426 to decipher a semantic understanding of the message 402 and pass the semantic understanding across each of the stages of the multi-stage automated process to prevent information loss. For example, a first component of the machine learning semantic search framework 416, a semantic searching component, may be configured to perform a semantic searching function using one or more natural language processing and/or natural language understanding models that leverage the domain knowledge index 426 to identify the precise nomenclature and terms to represent the concept that the sender had intended. In addition, or alternatively, a second component, an automated task resolution component, may be configured to perform an automated task associated with an automated task category 428 using the domain knowledge index 426 to identify the automated task category 428. In this way, the integration of the machine learning semantic search framework 416 and the domain knowledge index 426 may ensure sematic consistency from the initial intent understanding of a message to the processing of domain information, through a rules engine, and finally, the communicating one or more responses for the message 402.

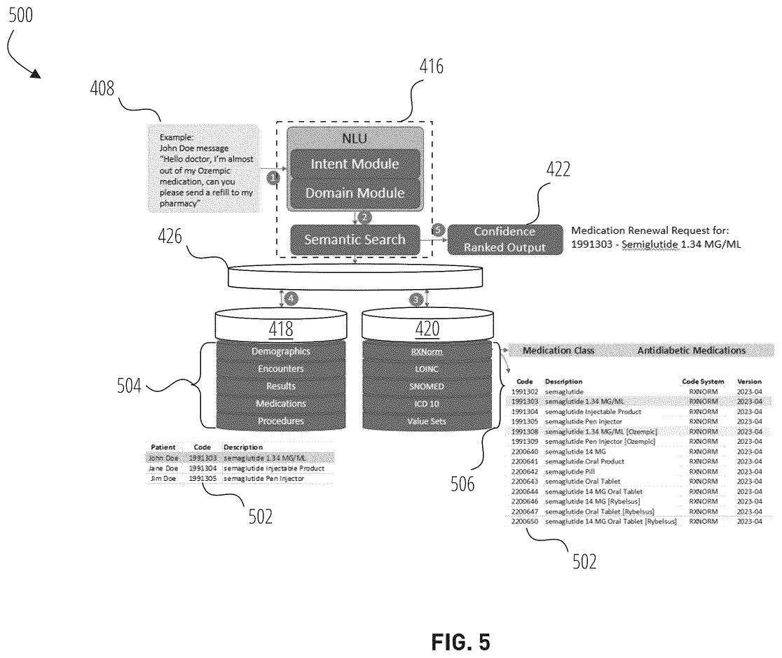

The semantic understanding may be initially derived, using the domain knowledge index 426 and several portions of the machine learning semantic search framework 416 through a message understanding pipeline that is described in further detail with reference to FIG. 5.

FIG. 5 is an operational example 500 of a message understanding pipeline for augmenting a message in accordance with some embodiments discussed herein. The message understanding pipeline may include a multi-stage semantic approach that leverages one or more components of the machine learning semantic search framework 416 and the domain knowledge index 426 to generate a coded model output 422 from message text data 408.

In some embodiments, a coded model output 422 is generated using an intent/domain and semantic search component of the machine learning semantic search framework 416. In some examples, an intent/domain and semantic search component of the machine learning semantic search framework 416 may include a message acquisition module and a message understanding module. The message acquisition module may acquire a message from a sender by rerouting the message, via an API, from a user inbox to the message understanding module. In some examples, the machine learning semantic search framework 416 may be configured to process the message prior to a user viewing the message. The message understanding module of the machine learning semantic search framework 416 that may process the message text data 408, using one or more natural language processing and/or natural language understanding models and the domain knowledge index 426, to identify a semantic intent classification and/or one or more shared embedding codes 502 representing an intent of the message. For example, the message understanding module may include a semantic search algorithm, which is enhanced by the domain knowledge index 426, to identify appropriate terminologies and codes to accurately represent a message's intent. These may then be used to search against historical data entities associated with a sender of the message to identify terminologies and codes that are tailored to a sender's history.

In some examples, the message understanding module may include a first portion that includes an encoding portion and an encoding comparison portion that are collectively configured to rank a plurality of domain data entities with respect to a message. For example, using a first portion of the machine learning semantic search framework 416, one or more shared embedding codes may be identified from a plurality of shared embedding codes based on the message text data 408 and the domain data index 418. For example, a semantic embedding of the message text data 408 may be generated using an encoding portion of the machine learning semantic search framework 416 and a semantic class may be identified that corresponds to the semantic embedding using an encoding comparison portion of the machine learning semantic search framework 416. In some examples, the one or more shared embedding codes may be identified based on the semantic class.

The encoding portion, for example, may include a machine learning encoding model, such as a pretrained BERT encoder, and/or the like, that is configured to generate a semantic embedding for a message based on the message text data 408 and/or a portion of the message text data 408. For instance, the semantic embedding may include an embedding of the message text data 408. In addition, or alternatively, the encoding portion may include a named entity recognition model (e.g., dictionary-based, rules-based, machine learning-based, etc.) configured to extract one or more domain-specific terms from the message text data 408 and the semantic embedding may include an embedding of the one or more domain-specific terms.

The encoding comparison portion may rank which of the plurality of domain data entities from the domain data index 418 aligns to the message with the highest degree of confidence. For example, the plurality of domain data entities may be ranked based on an embedding comparison between the semantic embedding and the shared embedding codes 502 respectively corresponding to the plurality of domain data entities. By way of example, the embedding comparison may include a cosine distance similarity, and/or the like. In some examples, encoding comparison portion may identify a semantic class corresponding to the message based on the ranked shared embedding codes.

In some embodiments, the semantic embedding is an encoded representation of at least a portion of the message text data 408 within a message. A semantic embedding, for example, may include an embedded representation of a message text data 408 and/or one or more terms extracted from the message text data 408, as described herein.

In some embodiments, the semantic class is a group of data entities within at domain data index 418. A semantic class, for example, may be a generic data entity that corresponds to a plurality of specific data entities within a prediction domain. The plurality of specific data entities, for example, may be aggregated from a plurality of domain data sources 504. By way of example, in a clinical prediction domain, a semantic class may be a generic medication class (e.g., without dosage information, etc.) and a specific data entity corresponding to the semantic class may be specific dosage, type, and intake of the generic medication class.

In some embodiments, the domain data sources 504 include a plurality of disparate data sources that store, manage, and/or the like, domain data associated with the domain data index 418. In some examples, the domain data index 418 may aggregate data from a plurality of domain data sources 504 associated with a prediction domain. Each of the domain data sources 504 may describe terminology associated with the particular prediction domain. As an example, in a clinical prediction domain, the plurality of domain data sources 504 may include an RXNorm, LOINC, SNOWMED, ICD 10, Value sets, and/or the like. In some examples, a plurality of domain data entities may be aggregated from the domain data sources 504 and assigned a shared embedding codes 502 that are synthesized across one or more historical data sources 506 of the domain knowledge index 426.

In some examples, using a second portion of the machine learning semantic search framework 416, a shared embedding code may be identified from the one or more shared embedding codes based on a sender identifier and the historical data index 420. For example, the sender identifier may be associated with the message 402. The message understanding module may include a second portion configured to identify a shared embedding code from the semantic class that is tailored to the sender of the message. The second portion, for example, may include a query logic that is configured to execute a plurality of queries to the historical data index 420 to identify a shared embedding code within the semantic class that corresponds to the sender of the message. In this manner, a semantic embedding code may be identified for a message that is both semantically relevant and personalized to a user.

In some embodiments, the historical data sources 506 are disparate data sources that store, manage, and/or the like, domain data associated with the historical data index 420. A historical data sources 506 may describe recorded attributes associated with a particular prediction domain. As an example, in a clinical prediction domain, a historical data source 506 may include patient clinical history repositories that describe one or more patient demographics, clinical encounters, clinical results, medications, procedures, and/or the like.

As described herein, the domain knowledge index 426 may integrate the domain data index 418 and the historical data index 420 to inform a machine learning semantic search framework 416 on the context of a sender's history while processing a message from the sender. In this way, by combining the domain data index 418 and historical data index 420 into the domain knowledge index 426, a message understanding module may filter through a plurality of relevant concept to identify a concept that is most relevant with respect to a message and the context in which the message is provided. By way of example, with reference to a clinical prediction domain, the domain knowledge index 426 and the message understanding module may be able to identify approximately 547 possible Ozempic codes that could align with a message based only on the message text data 408 and the domain data index 418. Using the connected historical data index 420, the message understanding module may be able to map the medication up to a medication class of ‘Antidiabetic Medication’ and search against a patient's active medications, finding an active prescription for Ozempic with dosage information enabling it to identify a single code out of the 547 possible codes to represent a message requesting a refill of a generic medication. Without the domain knowledge index 426, for example, the message understanding module may be limited to the generic code to represent Ozempic rather than the personalized code descriptive of the sender's actual intent.

In some embodiments, a semantic intent classification is generated for the message based on the message text data 408 and a model prompt. In some examples, semantic intent classification may be generated using a large language model portion of the machine learning semantic search framework 416. In some examples, a data source may be selected from the plurality of data sources associated with the domain knowledge index 426 based on the semantic intent classification and the shared embedding code may be identified based on the data source. In addition, or alternatively, the semantic intent classification may be generated using the shared embedding code.

For example, the message understanding module may include a third portion that is configured to identify a semantic intent classification for a message based on the shared embedding code and/or the message text data. The third portion, for example, may include a large language model, such as a generative pre-trained transformer, and/or the like, that is configured to generate a semantic intent classification in response to a model prompt and information from a message. The large language model, for example, may receive a model prompt that includes (i) a prompt requesting a semantic intent classification from one or more predefined semantic intent classifications, (ii) the shared embedding code, and/or (iii) the message text data 408 from the message. By way of example, in a clinical prediction domain, an example model prompt may ask if the message text data 408 is requesting a medication renewal and if so, whether the large language model may identify the medication requested. In some examples, the large language model may output an affirmative semantic intent classification and/or an alternative semantic intent classification for the message based on the model prompt.

In some embodiments, the semantic intent classification is a portion of a coded model output that describes a predicted intent of a message. A semantic intent classification, for example, may identify a task requested by the message.

In some embodiments, the model prompt is a generative model prompt for instructing a large language model to generate a semantic intent classification. For example, a large language model may be prompted with a text prompt to add context to message text data 408. The additional context may include a predefined template that corresponds to a shared embedding code. For example, the predefined template may include a predefined textual description and/or request that identifies one or more automated task categories that may correspond to a shared embedding code. In some examples, the predefined template may include one or more natural language instructions answering a question with respect to the shared embedding code. By way of example, a predefined template may state “Is the [message text data] requesting a refill for [shared embedding code].”

A model prompt may be dynamically configured based on a shared embedding code. For instance, one of one or more predefined templates may be identified based on the shared embedding code and the identified template may be modified, using the message text data 408 and/or the shared embedding code, to configure the model prompt.

In some examples, the semantic searching component may provide the identified terminologies and codes to an automated task resolution component to perform an automated task based on the message's intent. The automated task resolution component, for example, may include a rules engine that leverages the domain knowledge index 426 to increase the overall solution intelligence by removing the opportunity for misalignment in domain semantics. In some examples, this is enforced at a granular level by coding for this solution using Clinical Quality Language (CQL), which requires alignment to terminology and standardization.

As described herein, an automated task resolution component may perform an automated task by identifying an automated task category based on the coded model output 422. An example automated task category is discussed in further detail with reference to FIG. 6.

FIG. 6 is an operational example 600 of an automated task category in accordance with some embodiments discussed herein. The automated task category 428 is associated with a set of query assertions 602 and one or more predicted actions 604. In some examples, the set of query assertions 602 is decision logic for executing an automated task of an automated task category 428. The set of query assertions 602 may include one or more logic statements, each describing a computer-interpretable query for a shared embedding code. In some examples, the set of query assertions 602 may include a plurality of conditional queries. Each conditional query may include a query and a conditional logic for moving to a subsequent conditional query of the set of query assertions 602. In some examples, a query of a conditional query may include query logic for initiating a query to the domain knowledge index. The query logic, for example, may be executable by a query system to initiate a query to a historical data source integrated with the domain knowledge index and, in response to the query, receive a query response from the historical data source. The query logic, for example, may include an executable instruction for retrieving a particular data value type from a record accessible to a query system. A conditional logic of the conditional query may define an action in response to the query response. The action, for example, may define a subsequent conditional query of the set of query assertions 602. The set of query assertions 602 may terminate with one or more predicted actions 612 for responding to a message.

In some embodiments, a predicted action 612 is an entity that describes an anticipated action for handling a message. By way of example, using a Diuretic example, three predicted actions may be defined, including (i) if all conditions are met and no new health conditions have presented themselves, the clinician may renew the Diuretic medication in question for 6 months, (ii) if some of the conditions have not been met, the clinician may refill for a shorter duration, 100 days, and contact the patient to let them know what they need to do to renew again, and (iii) the clinician may end the prescription altogether, not renewing but informing the patient they no longer need the prescription.

A set of query assertions 602 may be specific to a prediction domain and/or the automated task categories defined within the prediction domain. For example, for a medication renewal request in a clinical prediction domain, the set of assertions may include a standardized rules-based protocol that guides an automated process for identifying specific fields in a patient's chart and comparing them to the same fields listed in the protocol to assess if the medication is appropriate for refill. As an example, for the renewal of a Diuretic medication, each time a Diuretic medication renewal is requested, an automated process may be performed to review the patient's chart to assess (a) the date of their last visit, (b) who the visit was with, (c) what lab tests were completed, (d) if they have had an electrolyte lab result in the last 6 months, and (c) what the value of the electrolyte lab was.

In order to inform a user for easier decision making with respect to an automated task category, operational protocols for an automated task category (e.g., the Diuretic example above) may be converted into executable logic (e.g., a set of assertions) where each criterion of the operational protocol is converted to a condition query for evidence and routing logic to another query or an end result of the protocol. By way of example, using the Diuretic medication renewal example, the set of query assertions 602 may include a first conditional query to request evidence of whether the patient has had an office visit in the last 12 months, a second conditional query to request evidence of whether the patient has had either a potassium or sodium test in the last 6 months, and/or the like. The inclusion of the domain knowledge index enables semantic consistency between the shared embedding code of the message and the set of query assertions 602. This may be further ensured by authoring the rules in Clinical Quality Language standard. By using this language, the terminology evaluation may be tied to the domain knowledge index thus enforcing the semantic consistency, ensuring improved overall solution intelligence. In addition, this approach allows for each rule to be reviewed and signed off by appropriate stakeholders with clinical oversight responsibilities with the knowledge that all terminology references are semantically accurate.

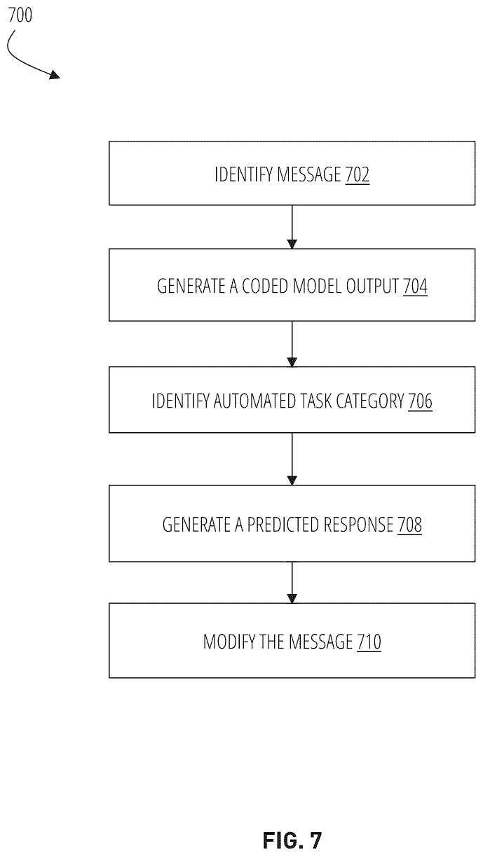

FIG. 7 is a flowchart diagram of an example process 700 for augmenting a message in accordance with some embodiments discussed herein. The flowchart depicts a multi-stage automated process 700 for communication systems with respect to message interpretation and routing. The process 700 may be implemented by one or more computing devices, entities, and/or systems described herein. For example, via the various steps/operations of the process 700, the computing system 101 may leverage an improved machine learning semantic search framework and domain knowledge index to intercept and augment a message enroute to user inbox. By doing so, the process 700 facilitates message handling techniques that are capable of identifying a semantic understanding of message and sharing the semantic understanding across each stage of a multi-stage process. This, in turn, allows for improved message handling operations by preventing information loss across multi-staged processes.

FIG. 7 illustrates an example process 700 for explanatory purposes. Although the example process 700 depicts a particular sequence of steps/operations, the sequence may be altered without departing from the scope of the present disclosure. For example, some of the steps/operations depicted may be performed in parallel or in a different sequence that does not materially impact the function of the process 700. In other examples, different components of an example device or system that implements the process 700 may perform functions at substantially the same time or in a specific sequence.

In some embodiments, the process 700 includes, at step/operation 702, identifying a message. For example, the computing system 101 may identify a message that (i) is directed to a user inbox, (ii) is associated with an automated task category of a plurality of different automated task categories, and (iii) comprises message text data reflective of the automated task category.

In some embodiments, the process 700 includes, at step/operation 704, generating a coded model output. For example, the computing system 101 may generate, using a machine learning semantic search framework, a coded model output (i) based on the message text data and a domain knowledge index and (ii) that comprises a semantic intent classification and a shared embedding code. In some examples, the shared embedding code is one of a plurality of shared embedding codes and the domain knowledge index comprises (i) a historical data index that comprises a plurality of historical data entries (a) from one or more historical data sources and (b) that respectively corresponds to the plurality of shared embedding codes, and (ii) a domain data index that comprises a plurality of domain data entries (a) from one or more domain data sources and (b) that respectively corresponds to the plurality of shared embedding codes. In some examples, the shared embedding code may be previously generated, using an encoding portion of the machine learning semantic search framework, for a domain data entity.

In some embodiments, the coded model output is based on a sender identifier associated with the message. The computing system 101 may identify, using a first portion of the machine learning semantic search framework, one or more shared embedding codes from the plurality of shared embedding codes based on the message text data and the domain data index, and identify, using a second portion of the machine learning semantic search framework, the shared embedding code from the one or more shared embedding codes based on the sender identifier and the historical data index. For example, the computing system 101 may generate, using an encoding portion of the machine learning semantic search framework, a semantic embedding of the message text data. The computing system 101 may identify, using an encoding comparison portion of the machine learning semantic search framework, a semantic class corresponding to the semantic embedding. The computing system 101 may identify the one or more shared embedding codes based on the semantic class.

In some examples, the computing system 101 may generate, using a large language model portion of the machine learning semantic search framework, the semantic intent classification for the message based on the message text data and a model prompt. In addition, or alternative, the computing system 101 may select a data source from a plurality of data sources associated with the domain knowledge index based on the semantic intent classification and identify the shared embedding code based on the data source.

In some embodiments, the process 700 includes, at step/operation 706, identifying an automated task category. For example, the computing system 101 may identify the automated task category based on the semantic intent classification and the shared embedding code. In some examples, the automated task category may include a set of query assertions that corresponds to a particular task for the shared embedding code. The computing system 101 may generate a sequence of queries for the historical data index based on the set of query assertions, execute the sequence of queries to receive a plurality of query responses, and generate the predicted response based on the plurality of query responses.

In some embodiments, the process 700 includes, at step/operation 708, generating a predicted response. For example, the computing system 101 may generate, using the domain knowledge index, a predicted response for the message based on the automated task category. In some examples, the predicted response may include (i) a text description reflective of the semantic intent classification and the shared embedding code, (ii) the plurality of query responses, and (iii) a predicted action for the message that is based on the plurality of query responses and the set of query assertions.

In some embodiments, the process 700 includes, at step/operation 710, modifying the message. For example, the computing system 101 may modify the message with the predicted response. In addition, or alternatively, the computing system 101 may identify a sender identifier associated with the message and provide an automated response to a sender inbox associated with a sender of the message based on the sender identifier and the coded model output.

Some techniques of the present disclosure enable the generation of action outputs that may be performed to initiate one or more real world actions to achieve real-world effects. The techniques of the present disclosure may be used, applied, and/or otherwise leveraged to augment a message, provide a communication, initiate a control of a device via one or more control instructions, and/or the like. Using some of the techniques of the present disclosure, a message may be interpreted to trigger the performance of actions at a client device, such as the display, transmission, and/or the like of data reflective of an augmented message and/or one or more predicted responses to the message. In some embodiments, a predicted response triggers an alert for a user. In addition, or alternatively, the predicted response may trigger (e.g., via one or more control instructions) an action by a robotic device to address a message intent (e.g., by unlocking an ingress/egress point of a building, etc.).

In some examples, the computing tasks may include actions that may be based on a prediction domain. A prediction domain may include any environment in which computing systems may be applied to interpret, store, and process data and initiate the performance of computing tasks responsive to the data. These actions may cause real-world changes, for example, by controlling a hardware component, providing alerts, interactive actions, and/or the like. For instance, actions may include the initiation of automated instructions across and between devices, automated notifications, automated scheduling operations, automated precautionary actions, automated security actions, automated data processing actions, and/or the like.

### VI. CONCLUSION

Many modifications and other embodiments will come to mind to one skilled in the art to which the present disclosure pertains having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

### VII. EXAMPLES

Some embodiments of the present disclosure may be implemented by one or more computing devices, entities, and/or systems described herein to perform one or more example operations, such as those outlined below. The examples are provided for explanatory purposes. Although the examples outline a particular sequence of steps/operations, each sequence may be altered without departing from the scope of the present disclosure. For example, some of the steps/operations may be performed in parallel or in a different sequence that does not materially impact the function of the various examples. In other examples, different components of an example device or system that implements a particular example may perform functions at substantially the same time or in a specific sequence.

Moreover, although the examples may outline a system or computing entity with respect to one or more steps/operations, each step/operation may be performed by any one or combination of computing devices, entities, and/or systems described herein. For example, a computing system may include a single computing entity that is configured to perform all of the steps/operations of a particular example. In addition, or alternatively, a computing system may include multiple dedicated computing entities that are respectively configured to perform one or more of the steps/operations of a particular example. By way of example, the multiple dedicated computing entities may coordinate to perform all of the steps/operations of a particular example.

Example 1. A computer-implemented method comprising identifying, by one or more processors, a message that (i) is directed to a user inbox, (ii) is associated with an automated task category of a plurality of different automated task categories, and (iii) comprises message text data reflective of the automated task category; generating, by the one or more processors and using a machine learning semantic search framework, a coded model output (i) based on the message text data and a domain knowledge index and (ii) that comprises a semantic intent classification and a shared embedding code; identifying, by the one or more processors, the automated task category based on the semantic intent classification and the shared embedding code; generating, by the one or more processors and using the domain knowledge index, a predicted response for the message based on the automated task category; and modifying, by the one or more processors, the message with the predicted response.

Example 2. The computer-implemented method of example 1, wherein the shared embedding code is one of a plurality of shared embedding codes and the domain knowledge index comprises: (i) a historical data index that comprises a plurality of historical data entries (a) from one or more historical data sources and (b) that respectively corresponds to the plurality of shared embedding codes, and (ii) a domain data index that comprises a plurality of domain data entries (a) from one or more domain data sources and (b) that respectively corresponds to the plurality of shared embedding codes.

Example 3. The computer-implemented method of example 2, wherein the automated task category comprises a set of query assertions that corresponds to a particular task for the shared embedding code and generating the predicted response for the message comprises: generating a sequence of queries for the historical data index based on the set of query assertions; executing the sequence of queries to receive a plurality of query responses; and generating the predicted response based on the plurality of query responses.

Example 4. The computer-implemented method of example 3, wherein the predicted response comprises (i) a text description reflective of the semantic intent classification and the shared embedding code, (ii) the plurality of query responses, and (iii) a predicted action for the message that is based on the plurality of query responses and the set of query assertions.

Example 5. The computer-implemented method of any of examples 2 through 4, wherein the coded model output is based on a sender identifier associated with the message and the computer-implemented method further comprises: identifying, using a first portion of the machine learning semantic search framework, one or more shared embedding codes from the plurality of shared embedding codes based on the message text data and the domain data index; and identifying, using a second portion of the machine learning semantic search framework, the shared embedding code from the one or more shared embedding codes based on the sender identifier and the historical data index.

Example 6. The computer-implemented method of example 5, wherein identifying the one or more shared embedding codes comprises generating, using an encoding portion of the machine learning semantic search framework, a semantic embedding of the message text data; identifying, using an encoding comparison portion of the machine learning semantic search framework, a semantic class corresponding to the semantic embedding; and identifying the one or more shared embedding codes based on the semantic class.

Example 7. The computer-implemented method of any of the preceding examples, wherein generating the coded model output comprises generating, using a large language model portion of the machine learning semantic search framework, the semantic intent classification for the message based on the message text data and a model prompt.

Example 8. The computer-implemented method of any of the preceding examples, wherein generating the coded model output further comprises selecting a data source from a plurality of data sources associated with the domain knowledge index based on the semantic intent classification; and identifying the shared embedding code based on the data source.

Example 9. The computer-implemented method of any of the preceding examples, further comprising identifying a sender identifier associated with the message; and providing an automated response to a sender inbox associated with a sender of the message based on the sender identifier and the coded model output.

Example 10. The computer-implemented method of any of the preceding examples, wherein the shared embedding code is a previously generated, using an encoding portion of the machine learning semantic search framework, for a domain data entity.

Example 11. A system comprising memory and one or more processors communicatively coupled to the memory, the one or more processors configured to identify a message that (i) is directed to a user inbox, (ii) is associated with an automated task category of a plurality of different automated task categories, and (iii) comprises message text data reflective of the automated task category; generate, using a machine learning semantic search framework, a coded model output (i) based on the message text data and a domain knowledge index and (ii) that comprises a semantic intent classification and a shared embedding code; identify the automated task category based on the semantic intent classification and the shared embedding code; generate, using the domain knowledge index, a predicted response for the message based on the automated task category; and modify the message with the predicted response.

Example 12. The system of example 11, wherein the shared embedding code is one of a plurality of shared embedding codes and the domain knowledge index comprises (i) a historical data index that comprises a plurality of historical data entries (a) from one or more historical data sources and (b) that respectively corresponds to the plurality of shared embedding codes, and (ii) a domain data index that comprises a plurality of domain data entries (a) from one or more domain data sources and (b) that respectively corresponds to the plurality of shared embedding codes.

Example 13. The system of example 12, wherein the automated task category comprises a set of query assertions that corresponds to a particular task for the shared embedding code and generating the predicted response for the message comprises generating a sequence of queries for the historical data index based on the set of query assertions; executing the sequence of queries to receive a plurality of query responses; and generating the predicted response based on the plurality of query responses.

Example 14. The system of example 13, wherein the predicted response comprises (i) a text description reflective of the semantic intent classification and the shared embedding code, (ii) the plurality of query responses, and (iii) a predicted action for the message that is based on the plurality of query responses and the set of query assertions.

Example 15. The system of any of examples 12 through 14, wherein the coded model output is based on a sender identifier associated with the message and the one or more processors are further configured to identify, using a first portion of the machine learning semantic search framework, one or more shared embedding codes from the plurality of shared embedding codes based on the message text data and the domain data index; and identify, using a second portion of the machine learning semantic search framework, the shared embedding code from the one or more shared embedding codes based on the sender identifier and the historical data index.

Example 16. The system of example 15, wherein identifying the one or more shared embedding codes comprises generating, using an encoding portion of the machine learning semantic search framework, a semantic embedding of the message text data; identifying, using an encoding comparison portion of the machine learning semantic search framework, a semantic class corresponding to the semantic embedding; and identifying the one or more shared embedding codes based on the semantic class.

Example 17. One or more non-transitory computer-readable storage media including instructions that, when executed by one or more processors, cause the one or more processors to identify a message that (i) is directed to a user inbox, (ii) is associated with an automated task category of a plurality of different automated task categories, and (iii) comprises message text data reflective of the automated task category; generate, using a machine learning semantic search framework, a coded model output (i) based on the message text data and a domain knowledge index and (ii) that comprises a semantic intent classification and a shared embedding code; identify the automated task category based on the semantic intent classification and the shared embedding code; generate, using the domain knowledge index, a predicted response for the message based on the automated task category; and modify the message with the predicted response.

Example 18. The one or more non-transitory computer-readable storage media of example 17, wherein generating the coded model output comprises generating, using a large language model portion of the machine learning semantic search framework, the semantic intent classification for the message based on the message text data and a model prompt.

Example 19. The one or more non-transitory computer-readable storage media of example 18, wherein generating the coded model output further comprises selecting a data source from a plurality of data sources associated with the domain knowledge index based on the semantic intent classification; and identifying the shared embedding code based on the data source.

Example 20. The one or more non-transitory computer-readable storage media of any of examples 17 through 20, wherein the one or more processors are further caused to identify a sender identifier associated with the message; and provide an automated response to a sender inbox associated with a sender of the message based on the sender identifier and the coded model output.

Example 21: The computer-implemented method of example 1, further comprising receiving training data for the machine learning semantic search framework and training the machine learning semantic search framework using the training data.

Example 22: The computer-implemented method of example 21, wherein the training is performed by the one or more processors.

Example 23: The computer-implemented method of example 21, wherein the one or more processors are included in a first computing entity; and the training is performed by one or more other processors included in a second computing entity.

Example 24: The system of example 11, wherein the one or more processors are further configured to receive training data for the machine learning semantic search framework and train the machine learning semantic search framework using the training data.

Example 25. The system of example 11, wherein the one or more processors are included in a first computing entity; and the machine learning semantic search framework is trained by one or more other processors included in a second computing entity.

Example 26. The one or more non-transitory computer-readable storage media of example 17, wherein the instructions further cause the one or more processors to train the machine learning semantic search framework.

Example 27. The one or more non-transitory computer-readable storage media of example 17, wherein the one or more processors are included in a first computing entity; and the machine learning semantic search framework is trained by one or more other processors included in a second computing entity.

1. A computer-implemented method comprising:
identifying, by one or more processors, a message that (i) is directed to a user inbox, (ii) is associated with an automated task category of a plurality of different automated task categories, and (iii) comprises message text data reflective of the automated task category;
generating, by the one or more processors and using a machine learning semantic search framework, a coded model output (i) based on the message text data and a domain knowledge index and (ii) that comprises a semantic intent classification and a shared embedding code;
identifying, by the one or more processors, the automated task category based on the semantic intent classification and the shared embedding code;
generating, by the one or more processors and using the domain knowledge index, a predicted response for the message based on the automated task category; and
modifying, by the one or more processors, the message with the predicted response.

2. The computer-implemented method of claim 1, wherein the shared embedding code is one of a plurality of shared embedding codes and the domain knowledge index comprises:
(i) a historical data index that comprises a plurality of historical data entries (a) from one or more historical data sources and (b) that respectively corresponds to the plurality of shared embedding codes, and
(ii) a domain data index that comprises a plurality of domain data entries (a) from one or more domain data sources and (b) that respectively corresponds to the plurality of shared embedding codes.

3. The computer-implemented method of claim 2, wherein the automated task category comprises a set of query assertions that corresponds to a particular task for the shared embedding code and generating the predicted response for the message comprises:
generating a sequence of queries for the historical data index based on the set of query assertions;
executing the sequence of queries to receive a plurality of query responses; and
generating the predicted response based on the plurality of query responses.

4. The computer-implemented method of claim 3, wherein the predicted response comprises (i) a text description reflective of the semantic intent classification and the shared embedding code, (ii) the plurality of query responses, and (iii) a predicted action for the message that is based on the plurality of query responses and the set of query assertions.

5. The computer-implemented method of claim 2, wherein the coded model output is based on a sender identifier associated with the message and the computer-implemented method further comprises:
identifying, using a first portion of the machine learning semantic search framework, one or more shared embedding codes from the plurality of shared embedding codes based on the message text data and the domain data index; and
identifying, using a second portion of the machine learning semantic search framework, the shared embedding code from the one or more shared embedding codes based on the sender identifier and the historical data index.

6. The computer-implemented method of claim 5, wherein identifying the one or more shared embedding codes comprises:
generating, using an encoding portion of the machine learning semantic search framework, a semantic embedding of the message text data;
identifying, using an encoding comparison portion of the machine learning semantic search framework, a semantic class corresponding to the semantic embedding; and
identifying the one or more shared embedding codes based on the semantic class.

7. The computer-implemented method of claim 1, wherein generating the coded model output comprises:
generating, using a large language model portion of the machine learning semantic search framework, the semantic intent classification for the message based on the message text data and a model prompt.

8. The computer-implemented method of claim 1, wherein generating the coded model output further comprises:
selecting a data source from a plurality of data sources associated with the domain knowledge index based on the semantic intent classification; and
identifying the shared embedding code based on the data source.

9. The computer-implemented method of claim 1, further comprising:
identifying a sender identifier associated with the message; and
providing an automated response to a sender inbox associated with a sender of the message based on the sender identifier and the coded model output.

10. The computer-implemented method of claim 1, wherein the shared embedding code is a previously generated, using an encoding portion of the machine learning semantic search framework, for a domain data entity.

11. A system comprising memory and one or more processors communicatively coupled to the memory, the one or more processors configured to:
identify a message that (i) is directed to a user inbox, (ii) is associated with an automated task category of a plurality of different automated task categories, and (iii) comprises message text data reflective of the automated task category;
generate, using a machine learning semantic search framework, a coded model output (i) based on the message text data and a domain knowledge index and (ii) that comprises a semantic intent classification and a shared embedding code;
identify the automated task category based on the semantic intent classification and the shared embedding code;
generate, using the domain knowledge index, a predicted response for the message based on the automated task category; and
modify the message with the predicted response.

12. The system of claim 11, wherein the shared embedding code is one of a plurality of shared embedding codes and the domain knowledge index comprises:
(i) a historical data index that comprises a plurality of historical data entries (a) from one or more historical data sources and (b) that respectively corresponds to the plurality of shared embedding codes, and
(ii) a domain data index that comprises a plurality of domain data entries (a) from one or more domain data sources and (b) that respectively corresponds to the plurality of shared embedding codes.

13. The system of claim 12, wherein the automated task category comprises a set of query assertions that corresponds to a particular task for the shared embedding code and generating the predicted response for the message comprises:
generating a sequence of queries for the historical data index based on the set of query assertions;
executing the sequence of queries to receive a plurality of query responses; and
generating the predicted response based on the plurality of query responses.

14. The system of claim 13, wherein the predicted response comprises (i) a text description reflective of the semantic intent classification and the shared embedding code, (ii) the plurality of query responses, and (iii) a predicted action for the message that is based on the plurality of query responses and the set of query assertions.

15. The system of claim 12, wherein the coded model output is based on a sender identifier associated with the message and the one or more processors are further configured to:
identify, using a first portion of the machine learning semantic search framework, one or more shared embedding codes from the plurality of shared embedding codes based on the message text data and the domain data index; and
identify, using a second portion of the machine learning semantic search framework, the shared embedding code from the one or more shared embedding codes based on the sender identifier and the historical data index.

16. The system of claim 15, wherein identifying the one or more shared embedding codes comprises:
generating, using an encoding portion of the machine learning semantic search framework, a semantic embedding of the message text data;
identifying, using an encoding comparison portion of the machine learning semantic search framework, a semantic class corresponding to the semantic embedding; and
identifying the one or more shared embedding codes based on the semantic class.

17. One or more non-transitory computer-readable storage media including instructions that, when executed by one or more processors, cause the one or more processors to:
identify a message that (i) is directed to a user inbox, (ii) is associated with an automated task category of a plurality of different automated task categories, and (iii) comprises message text data reflective of the automated task category;
generate, using a machine learning semantic search framework, a coded model output (i) based on the message text data and a domain knowledge index and (ii) that comprises a semantic intent classification and a shared embedding code;
identify the automated task category based on the semantic intent classification and the shared embedding code;
generate, using the domain knowledge index, a predicted response for the message based on the automated task category; and
modify the message with the predicted response.

18. The one or more non-transitory computer-readable storage media of claim 17, wherein generating the coded model output comprises:
generating, using a large language model portion of the machine learning semantic search framework, the semantic intent classification for the message based on the message text data and a model prompt.

19. The one or more non-transitory computer-readable storage media of claim 18, wherein generating the coded model output further comprises:
selecting a data source from a plurality of data sources associated with the domain knowledge index based on the semantic intent classification; and
identifying the shared embedding code based on the data source.

20. The one or more non-transitory computer-readable storage media of claim 17, wherein the one or more processors are further caused to:
identify a sender identifier associated with the message; and
provide an automated response to a sender inbox associated with a sender of the message based on the sender identifier and the coded model output.
